(19) United States
(12) Patent Application Publication
(10) Pub. No.: US 2017/0373836 A1
(43) Pub. Date: Dec. 28, 2017

(54) AES Hardware Implementation

(71) Applicant: Imagination Technologies Limited, Kings Langley (GB)

(72) Inventor: Leonard Rarick, San Diego, CA (US)

(21) Appl. No.: 15/633,988

(22) Filed: Jun. 27, 2017

Related U.S. Application Data
(60) Provisional application No. 62/355,443, filed on Jun. 28, 2016.

(51) Int. Cl. H04L 9/06; H04L 9/08; H04L 9/14

(52) U.S. Cl. CPC H04L 9/0631; H04L 9/14; H04L 9/0861; H04L 9/0891; H04L 9/0894

(57) ABSTRACT

A method of performing at least one of end-to-end Advanced Encryption Standard (AES) encryption and end-to-end AES decryption in an instruction execution module comprising hardware logic in a processor having an instruction set, receives in response to a particular instruction set being executed, key values and text data identified by operands in the executed instruction, the received key values defining an initial round key and forming current key values and the received text data defining an initial state array to be processed in an initial round and forming a current state array; and for each round of a plurality of rounds of

AES encryption or decryption, modifying the current key values and modifying the current state array by: processing the current state array using at least a portion of the current key values; generating key values based upon the current key values for use in a subsequent round; and updating the current key values to replace at least a portion of the current key values with the generated key values to form a round key for use in a subsequent round.

### BACKGROUND

The Advanced Encryption Standard (AES) defines a standardised symmetric key encryption and corresponding decryption technique that has become widespread in its use.

AES provides the capability to encrypt message text or to decrypt cipher text of a fixed size in the form of a “state” array using key data. AES encryption and decryption algorithms define a number of rounds that are performed as part of the encryption or decryption process. A fundamental aspect to the AES standard is a technique of key expansion which is performed to expand an initial set of key data values so that the expanded key values can be used to process rounds of AES encryption or decryption.

When implementing AES in hardware, one approach is to pre-perform key expansion of the initial set of key data values to generate an entire key schedule that comprises all round keys to be used the rounds. Using this approach, the entire key schedule is stored in memory and, for each round, the round key to be used is retrieved from the memory and used to process that round. This approach requires memory to store the entire key schedule.

In addition, AES is typically implemented in a general purpose CPU by specifying in the instruction set of the CPU a number of different instructions each configured to perform a round or part of a round of the AES procedure. Each instruction in a program for performing AES may have as operands the key data to be used in that round and the current state array values. This implementation of AES is slow to execute since multiple instructions need to be issued to the CPU and multiple reads from the memory are required. Moreover, code size is increased and a number of op-codes within the instruction set of the CPU are taken up by each type of round to be processed. There is therefore a need for an improved approach to implementing the AES standard in hardware logic in a processor which overcomes these problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

There is provided a method of performing at least one of end-to-end AES encryption and end-to-end AES decryption in an instruction execution module comprising hardware logic in a processor having an instruction set, the method comprising: receiving in response to a particular instruction from the instruction set being executed, key values and text data identified by operands in the executed instruction, the received key values defining an initial round key and forming current key values and the received text data defining an initial state array to be processed in an initial round and forming current key values and the received text data defining an initial state array to be processed in an initial round and forming a current state array; and for each round of a plurality of rounds of AES encryption or decryption, modifying the current key values and modifying the current state array by: processing the current state array using at least a portion of the current key values; generating key values based upon the current key values for use in a subsequent round; and updating the current key values to replace at least a portion of the current key values with the generated key values to form a round key for use in a subsequent round.

There is provided a processor having an instruction set, the processor comprising an instruction execution module comprising hardware logic configured to perform at least one of end-to-end AES encryption and end-to-end AES decryption, the instruction execution module configured to: receive in response to a particular instruction from the instruction set being executed, key values and text data identified by operands in the executed instruction, the received key values defining an initial round key and forming current key values and the received text data defining an initial state array to be processed in an initial round and forming a current state array; and for each round of a plurality of rounds of AES encryption or decryption, modify the current key values and modifying the current state array by: processing the current state array using at least a portion of the current key values; generating key values based upon the current key values for use in a subsequent round; and updating the current key values to replace at least a portion of the current key values with the generated key values to form a round key for use in a subsequent round.

There is provided a processor having an instruction set, the processor comprising hardware logic configured to perform at least one of end-to-end AES and end-to-end AES decryption, the hardware logic configured to: hold received key values, the key values forming a round key; hold received text data, the text data forming a state array to be processed; and for a plurality of rounds of AES encryption or decryption: process the state array using at least a portion of the held key values; generate key values based upon the held key values for use in a subsequent round; and update the held key values to replace at least a portion of the held key values with the generated key values.

There is provided a processor having an instruction set, the processor comprising hardware logic configured to perform at least one of end-to-end AES and end-to-end AES decryption, the hardware logic configured to: receive an instruction comprising key values forming a round key and text data forming a state array to be processed; hold, in registers, the received key values and the received text data; and for a plurality of rounds of AES encryption or decryption: process the state array using at least a portion of the held key values; and generate key values based upon the held key values for use in a subsequent round and hold the generated key values in at least one register.

The steps of processing the current state array and generating key values for a particular round may comprise a first stage and a second stage. For a particular round, the first stage may comprise: completing generation of key values by processing partially generated key values that had been initiated in a previous round and holding the generated key values; and initiating the processing of the current state array to generate partially processed text values; and the second stage may comprise: initiating generation of key values for the next round to generate partially generated key values; and completing the processing of the current state array for the round based upon the partially processed text values.

The first stage of processing a particular round may further comprise holding in a Text Keep register partially processed text values and, the second stage of processing a particular round may further comprise holding in a Text Keep register partially processed key values.

A Key Expand module may be further configured to perform at least a portion of the generation of key values. The Key Expand module may be configured to generate key values based upon which of AES encryption or decryption is to be performed and the AES key length to be used. The Key Expand module may be configured, in the first stage, to complete the generation of key values based upon partially generated key values.

An SBox module may be configured to perform at least one SBox transformation. The SBox module may be configured to operate in a first mode and at least one of a second mode and a third mode, wherein the first mode is a key expansion mode, a second mode is an encryption mode, and a third mode is a decryption mode. The SBox module may be configured to operate in the first mode during the second stage and is configured to operate in either a second mode or a third mode during the first stage. The SBox module may be configured, in the first stage, to generate partially processed text values and to hold the partially processed text values in the Text Keep register and may be configured, in the second stage, to generate partially processed key values and to hold the partially processed key values in the Text Keep register. The SBox module may be configured to perform sixteen SBox transformations in parallel.

The received text data may form a first current state array. Second received key values may be received, the second received key values defining a second initial round key for processing second end-to-end AES encryption or decryption and second text data may be received forming a second current state array to be processed in parallel with the first current state array; and wherein the SBox module may be a first SBox module and the method may further comprise processing key data using a second SBox module and processing text data using the first SBox module. The SBox module may be configured to perform an SBox transformation on four bytes in parallel.

A first stage of processing a particular round, may comprise: completing generation of first key values by processing partially generated first key values that had been initiated in a previous round and holding the first generated key values; and initiating the processing of the first current state array to generate partially processed first text values; completing the processing of the second current state array using current second key values; and initiating generation of second key values for the next round to generate partially generated second key values; and in a second stage of processing a particular round: completing generation of second key values by processing partially generated second key values; initiating the processing of the second current state array to generate partially processed second text values; completing the processing of the first current state array using first key values; and initiating generation of first key values for the next round to generate partially generated first key values.

Processing a current state array using at least a portion of the current key values may comprise a plurality of stages in which a portion of the current state array undergoes an SBox transformation in a respective stage of a plurality of stages and a further stage in which key values are generated.

The instruction set may comprise a plurality of instructions each respectively defining which of encryption or decryption to perform and the AES key length to use. A configuration of the hardware logic to operate in one of a number of different modes of operation may be based upon the opcode of a received instruction from the instruction set.

The processor may be embodied in hardware on an integrated circuit. There may be provided a method of manufacturing, at an integrated circuit manufacturing system, a processor. There may be provided an integrated circuit definition dataset that, when processed in an integrated circuit manufacturing system, configures the system to manufacture a processor. There may be provided a non-transitory computer readable storage medium having stored thereon a computer readable description of an integrated circuit that, when processed, causes a layout processing system to generate a circuit layout description used in an integrated circuit manufacturing system to manufacture a processor.

There may be provided an integrated circuit manufacturing system comprising: a non-transitory computer readable storage medium having stored thereon a computer readable integrated circuit description that describes the processor; a layout processing system configured to process the integrated circuit description so as to generate a circuit layout description of an integrated circuit embodying the processor; and an integrated circuit generation system configured to manufacture the processor according to the circuit layout description.

There may be provided computer program code for performing a method as claimed in any preceding claim. There may be provided non-transitory computer readable storage medium having stored thereon computer readable instructions that, when executed at a computer system, cause the computer system to perform the method as claimed in any preceding claim.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 shows an overview of structure of AES algorithms;

FIG. 2 shows a detailed overview of the AES encryption algorithm;

FIG. 3 shows an overview of the AddRoundKey( ) function;

FIG. 4 shows an overview of the ShiftRows( ) function;

FIG. 5 shows an overview of the MixColumns( ) function;

FIG. 6 shows hardware logic for implementing in hardware AES according to a first example;

FIG. 7 shows the operation of an initial round of the AES implementation of FIG. 6;

FIG. 8 shows the operation of a first stage of an intermediate round of the AES implementation of FIG. 6;

FIG. 9 shows the operation of a second stage of an intermediate round of the AES implementation of FIG. 6;

FIG. 10 shows the operation of a final round of the AES implementation of FIG. 6;

FIG. 11 shows a detailed overview of the AES decryption algorithm;

FIG. 12 shows an overview of the InvShiftRows( ) function;

FIG. 13 shows an overview of the InvMixColumns( ) function;

FIG. 14 shows an example implementation of an SBox module;

FIG. 15 shows example logic circuitry for implementing key generation instruction and on-the-fly AES128 key expansion for encryption;

FIG. 16 shows example logic circuitry for implementing an initial round of on-the-fly AES128 key expansion for decryption;

FIG. 17 shows example logic circuitry for implementing a subsequent round of on-the-fly AES128 key expansion for decryption;

FIG. 18 shows example logic circuitry for implementing key generation instruction and on-the-fly AES256 key expansion for encryption;

FIG. 19 shows example logic circuitry for implementing on-the-fly AES256 key expansion for decryption;

FIG. 20 shows example logic circuitry for implementing on-the-fly AES192 key expansion for encryption;

FIGS. 21 to 23 show logic circuitry for implementing key generation instruction and on-the-fly AES192 key generation for encryption;

FIG. 24 shows example logic circuitry for implementing on-the-fly AES192 key expansion for decryption;

FIG. 25 shows example hardware logic for implementing in hardware AES according to a second example;

FIG. 26 shows the operation of a first stage of an intermediate round of the AES implementation of FIG. 25;

FIG. 27 shows the operation of a second stage of an intermediate round of the AES implementation of FIG. 25

FIG. 28 shows the double throughput operation of a first stage of an intermediate round of the AES implementation of FIG. 25;

FIG. 29 shows the double throughput operation of a second stage of an intermediate round of the AES implementation of FIG. 25;

FIG. 30 shows a plurality of stages to be performed in an initial round of a hardware implementation according to a third example;

FIG. 31 shows hardware logic for implementing in hardware AES for encryption according to a third example;

FIG. 32 shows a further illustration of the AES implementation according to the third example of FIG. 31;

FIG. 33 shows hardware logic for implementing in hardware AES for decryption according to the third example;

FIG. 34 shows the operation of a first portion of a first stage of an initial round for encryption according to the third example of FIG. 31;

FIG. 35 shows the operation of a first portion of a first stage of an initial round for decryption according to the third example of FIG. 31;

FIG. 36 shows the operation of a second portion of a first stage of an initial round for encryption according to the third example of FIG. 31;

FIG. 37 shows the operation of second to fifth stages of an initial round for encryption according to the third example of FIG. 31;

FIG. 38 shows the operation of a sixth stage of an initial round for encryption according to the third example of FIG. 31;

FIG. 39 shows the operation of a sixth stage of an initial round for decryption according to the third example of FIG. 31;

FIG. 40 shows a computer system in which hardware logic for implementing AES in hardware is implemented; and

FIG. 41 shows an integrated circuit manufacturing system for generating an integrated circuit embodying hardware logic for implementing in AES hardware.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

The Advanced Encryption Standard (AES) algorithm is a symmetric block cipher that is configured to encrypt message data to form ciphertext and to decrypt ciphertext to convert the ciphertext back to the original form of the text, referred to as message data or plaintext. The AES standard specifies cryptographic keys of three different lengths, namely 128, 192, and 256 bits which are respectively referred to as AES128, AES192, and AES256. The text to be encrypted or decrypted is of a fixed length of 128 bits arranged in a 4×4 byte array.

At the beginning of the encryption or decryption process, the 4×4 byte array is copied into another array, referred to as the ‘state’ array, upon which operations are performed over a predetermined number of rounds until the output ciphertext (for encryption) or plaintext (for decryption) is generated. The output ciphertext or plaintext is also 128 bits in length and may also in the form of a 4×4 byte array.

For decryption, a 4×4 byte array of 128 bits of ciphertext is input in the form of a 4×4 byte array. The ciphertext is then copied into the state array and operations are performed on the state array over a predetermined number of rounds until the message text, or plaintext, is output.

The examples described herein relate to an end-to-end AES encryption and/or decryption instruction execution module which comprises hardware logic that is configured to be implemented within a processor, for example a general purpose processor. The instruction execution module comprises hardware logic which will be described in more detail below. In general, the module is configured to receive a set of initial key values and an initial set of text values which are retrieved from memory of the processor in accordance with an instruction executed within the processor. In response to the instruction being executed and the key and text data being received by the hardware logic of the instruction execution module, the hardware logic is configured to perform end-to-end AES encryption and/or decryption. In this way, it is only necessary to issue a single instruction to perform a complete AES encryption or decryption process. In addition, the instruction execution module is configured to generate on-the-fly key data for use in processing rounds so that it is only necessary to store the initial key values needed to generate subsequent key values. The instruction execution module is configured to perform AES encryption and/or decryption in response to an instruction provided by the processor. Put another way, the instruction execution module is configured to carry out the execution of an instruction of the processor and not as an independent adjunct unit.

AES Algorithm

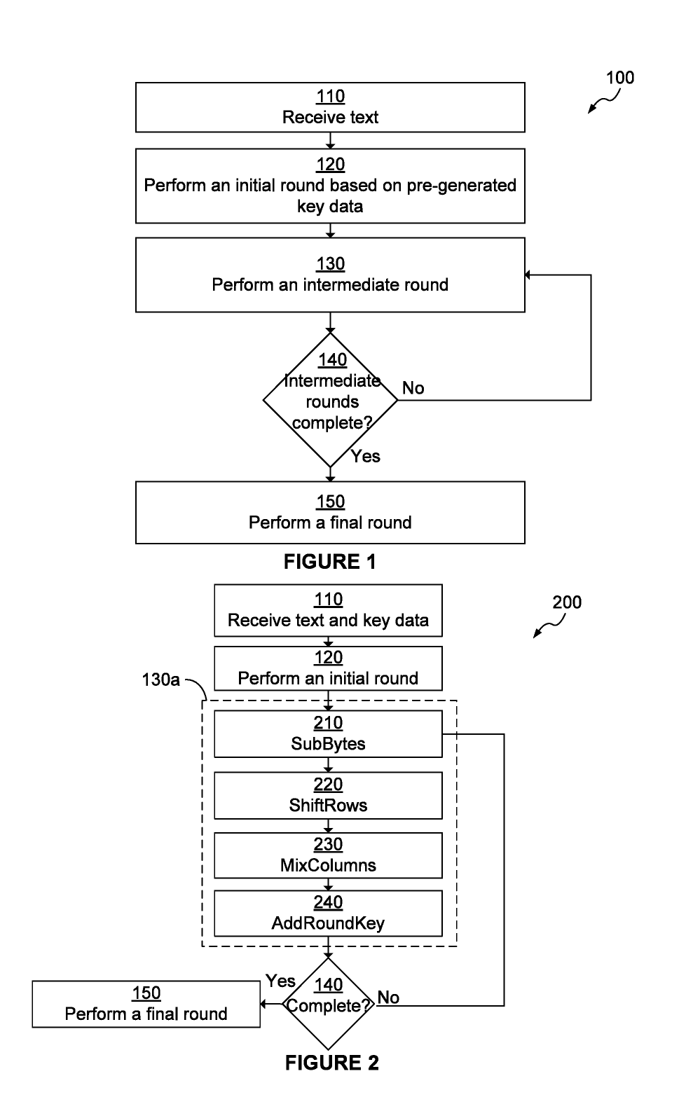

Before describing examples according to the present disclosure, an overview of the AES algorithm is set out below with reference to FIG. 1 which illustrates a process for performing the AES algorithm. The steps described in FIG. 1 are applicable to both encryption and decryption. However, it should be noted that the specific calculations performed at each step differ between encryption and decryption.

For encryption, at step 110, key data and message text data is input into the algorithm. The length of the key may be one of 128, 192, and 256 bits in length. The key length may be represented by N_{K}, which represents the number of 32-bit words in the cipher key. For example, a 128-bit cipher key may be represented as N_{K}=4, a 192-bit cipher key may be represented as N_{K}=6, and a 256-bit cipher key may be represented as N_{K}=8.

Having received the text and key data, the AES algorithm proceeds to step 120 in which an initial round is performed. Having completed the initial round, the AES algorithm proceeds to step 130 in which an intermediate round is performed. Having completed the intermediate round, the algorithm proceeds to step 140 in which it is determined whether or not a predetermined number of intermediate rounds have been completed. The predetermined number of rounds, N_{R}, that are to be performed is dependent on the length of the key that is to be used. For AES, where N_{K}=4, then N_{R}=10; where N_{K}=6, then N_{R}=12; and where N_{K}=8, then N_{R}=14.

For the arrangement of FIG. 1, the number of rounds performed is tracked (for example, using a counter) and, when the number of rounds performed reaches the predetermined number of rounds N_{R}, as determined in step 140, the algorithm proceeds to step 150 in which a final round is performed. After completion of the final round, the encryption or decryption is completed and the resultant 128-bit ciphertext or plaintext is output.

### Key Expansion

As described above, the AES algorithm receives an input key of a fixed length, either N_{K}=4, N_{K}=6, or N_{K}=8. When implementing AES a process of key expansion is performed prior to executing the AES procedure of FIG. 1. Key expansion involves expanding an initially received set of key values to generate a further set of key values comprising separate round keys for use in each round (whether encryption or decryption). The initially received set of key values form a round key for an initial round and the round keys for the intermediate round and the final round are derived from the initially received set of key values using Rijndael's key schedule.

Key expansion is performed on an input key K to generate a key schedule by generating 4*(N_{R}+1) words based upon an initial set of N_{K} four-byte words, where each round requires 4 words of key data. The resulting key schedule, which forms the expanded cipher key, consists of a linear array of 4-byte words, denoted [wᵢ], with i in the range 0≦i<4*(N_{R}+1). The process for generating a key schedule based upon an initial input key is illustrated with the following pseudo-code:

```
KeyExpansion(byte key[4*Nk], word w[4*(Nr+1)], Nk)
begin
    word temp
    i = 0
    while (i < Nk)
        w[i] = word(key[4*i], key[4*i+1], key[4*i+2],
    key[4*i+3])
        i = i+1
    end while
    i = Nk
    while (i < 4 * (Nr+1)]
        temp = w[i−1]
        if (i mod Nk = 0)
            temp = SubWord(RotWord(temp)) xor RCon[i/Nk]
        else if (Nk > 6 and i mod Nk = 4)
            temp = SubWord(temp)
        end if
        w[i] = w[i−Nk] xor temp
        i = i + 1
    end while
end
```

The N_{K} 4-byte words of the initial received key values are copied into the first N_{K} 4-byte words of the key schedule w. After the initial key has been copied into the key schedule, for each round of the N_{R} rounds that are to be performed, 4 words of key data are generated in the key schedule. The determination of each subsequent word of the key schedule w[i] is performed based upon an XOR of the previous word in the key schedule value w[i-1] with a word in the key schedule w[i-N_{K}] that is N_{K} words earlier.

For words in the key schedule that are a multiple of N_{K}, a transformation is applied to w[i-1] prior to the XOR calculation. Specifically, in these circumstances w[i-1] is transformed using a function RotWord( ) which takes as an input a 4-byte word [α₀, a₁, a₂, a₃] and performs a cyclic permutation to return the 4-byte word [a₁, a₂, a₃, a₀]. The result of performing the function RotWord( ) on the previous word in the key schedule is then processed according to the function SubWord( ).

The function SubWord( ) is configured to receive a four-byte word as an input and to apply to each of the four bytes an SBox function to produce a four-byte output word, as specified in the AES standard (Advanced Encryption Standard (AES), Processing Standards Publication 197, 26 November 2001).

As can be seen from the above pseudo-code, a second alternative process is applied when performing key expansion which arises from the fact that, in AES, 128- and 192-bit keys are processed differently to AES implementations for 256-bit keys. Specifically, for 256-bit keys (i.e. where N_{K}=8), where i-4 is a multiple of N_{K}, the previous key schedule value w[i-1] undergoes processing by the SubWord( ) function and is then XOR'd with w[i-N_{K}].

As a result of the key expansion process that produces the key schedule, a set of four-byte words is produced comprising a total of (4*(N_{R}+1)) words, and each for each round four words of the key schedule are used. Where the cipher key for the AES algorithm is 128-bits in length (i.e. N_{K}=4), then the total number of words i in the key schedule is 44 and each word contains four bytes (32 bits). The total number of bits needed to represent the key schedule for a 128-bit key is therefore 1408 bits. Similarly, where the cipher key is 192-bits in length, the total number of words in the key schedule is 52 and therefore the total number of bits needed to represent the key schedule for a 192-bit key is 1664. Similarly, where the cipher key is 256-bits in length, the total number of words in the key schedule is 60 and therefore the total number of bits needed to represent the key schedule for a 256-bit key is 1920.

When implemented as part of a general purpose CPU, a key schedule may be generated in its entirety prior to the execution of the AES algorithm based upon the initially received cipher key. For example, in some implementations of the AES standard in hardware logic on a general purpose CPU, the entire key schedule is generated and stored in a memory. The CPU may therefore perform the processing of the AES algorithm based upon the key schedule stored in memory. For each round performed, a different portion of the key schedule is used. However, due to the size of the expanded key schedule (1920 bits for a 256-bit key), it is not possible to provide to the CPU a single instruction to perform end-to-end AES encryption or decryption, where end-to-end AES encryption or decryption can be considered to be the complete encryption or decryption process including performing the initial round, each intermediate round, and the final round to generate the encrypted or decrypted result. The reason that it is not possible to provide the CPU with a single instruction for end-to-end encryption or decryption is that typically CPUs typically define the operand to have a limited bit width which is far smaller than the size of the entire key schedule.

As such, hardware implementations of the AES algorithm within a general purpose CPU are forced to define within the instruction set of that CPU an instruction for performing a single round or parts of a single round of the AES algorithm, so that only the portion of the key schedule for that round is provided as an operand. In this way, the instruction issued to the CPU will include the 128-bit text data to be processed and the four words (four-byte words) of the round key for that particular round as operands. For encryption, the round key used can be considered to be located at the start of the key schedule (e.g. the first four entries). For each subsequent round, the round key used can be considered to be taken from the next location in the key schedule such that keys for subsequent rounds are selected in a forwards direction. In a corresponding manner, for decryption, the key values may be selected from the end of the key schedule and, each round, the selection may be considered to move backwards.

Executing in hardware the AES algorithm (whether for encryption or decryption) by defining a separate instruction for each round of AES is not efficient. Moreover, it is typical to pre-generate each round key for the round to form a key schedule to be processed in advance. For example, in some arrangements, the entire key schedule is generated using the key expansion prior to executing the AES algorithm. Pre-generating the key schedule increases the delay incurred before the AES algorithm can be executed by the CPU. Moreover, memory resources are required to store the key schedule prior to performing the AES algorithm, and execution of the process is slow since multiple instructions must be handled and multiple fetches to an external memory must be performed to retrieve the stored key values.

On-The-Fly

The example methods and apparatuses described herein provide an alternative approach to implementing hardware that is configured to implement end-to-end AES encryption and/or decryption. That is, the methods and apparatuses are able to implement in sequence all of the rounds necessary to implement the entire encryption and/or decryption processes based upon the issuance, decode, and execution of a single instruction. Put another way, it is not necessary to issue multiple instructions to the hardware logic or issue separate control signals to the hardware logic for each round to be performed. The hardware logic is able to generate key information for use in all rounds based on initially received key information and the text to be encrypted or decrypted. To do this, the examples provided are able to calculate the round key for the next round “on-the-fly” without the need to retrieve further key information for each round from memory or the need for a further instruction to be executed, based upon key information generated in the previous round. In addition, there is no need to use an adjunct module for encryption or decryption.

Furthermore, the hardware logic described herein is configured such that only the key values needed to generate subsequent round keys are stored in memory, thereby reducing internal memory requirements. For example, it is only necessary to store in memory either the initial key values of the key schedule (for encryption) or the final key values (for decryption). Moreover, in the processing of subsequent rounds, the hardware implementations may only hold in registers only a subset of the key schedule, e.g. eight key values from the key schedule, in order to generate further key values.

The apparatuses and methods described herein have particular application within the context of use with a general purpose CPU having a pre-defined instruction set. Since the hardware implementations described herein are configured to receive input text and initial key values, the operation of the hardware implementation is not restricted by the limited operand size of general purpose processors. By calculating a round key based on prior key information, it is possible to generate a round key for a subsequent round of the AES algorithm without the need to externally store the key information or to receive an instruction having the key information. Example implementations of these methods and apparatuses are described below with reference to a more detailed explanation of AES encryption and decryption.

Encryption

An example of the AES encryption algorithm 200 according to a prior implementation is provided in more detail in FIG. 2, in which message text is encrypted to generate ciphertext. In the prior implementation of FIG. 2, it is assumed that the entire key schedule is already generated and is stored in memory and available for use in each round. The encryption algorithm 200 is also to illustrated in the following pseudo-code:

```
Cipher(byte in[16], byte out[16], word w[4*(Nr+1)])
begin
    byte state[4,4]
    state = in
    AddRoundKey(state, w[0, 3])
    for round = 1 step 1 to Nr−1
        SubBytes(state)
        ShiftRows(state)
        MixColumns(state)
        AddRoundKey(state, w[4*round, 4*round+3])
    end for
    SubBytes(state)
    ShiftRows(state)
    AddRoundKey(state, w[4*round, 4*round+3])
    out = state
end
```

### AddRoundKey( )

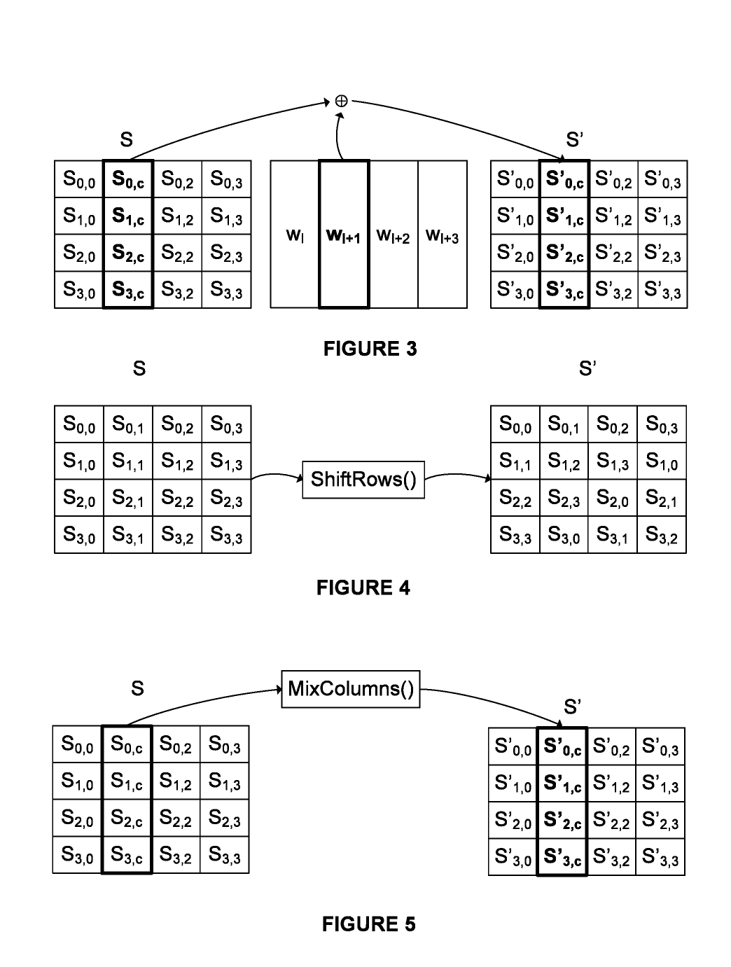

In step 110 of FIG. 2, the message text that is to be converted into ciphertext is input and the method proceeds to step 120 in which an initial round is performed based upon the first four words of the complete (pre-generated) key schedule. In the initial round for AES encryption, an AddRoundKey( ) transformation is performed in which a round key is added to the state array using a bitwise XOR operation as illustrated in FIG. 3. In this prior implementation, the initial round key is read from memory and used as an operand in an issued instruction to perform the initial round the resultant processed state array. Each round key consists of 4 words from the key schedule which are applied to columns of the state array, as shown in Equation (2) below for 0≦c<4:

[s′_{0,c},s′_{1,c},s′_{2,c},s′_{3,c}]=[s_{0,c},s_{1,c},s_{2,c},s_{3,c}]⊕[w_{round*N}_{_{b+c}}] (1)

Where s_{x,y} is the value of the state at position x, y of the 4×4 byte array of the state array, wᵢ comprises a four-byte key schedule word, and round is the number of the round that is being performed, which falls within the range 0≦round<N_{R}. For the initial round performed at step 120, round=0.

The performance of the AddRoundKey( )transformation is illustrated in relation to FIG. 3, in which four bytes which represent a column of the state array (e.g. [s_{0,c},s_{1,c}, s_{2,c}, s_{3,c}]) are combined using an XOR operator with the four bytes (i.e. a word) of element wₗ₊₁ of the key schedule to create new values for that particular column of four bytes of data of the state (e.g. [s′_{0,c}, s′_{1,c}, s′_{2,c}, s′_{3,c}]), where l=round*4. The AddRoundKey( ) function therefore receives state array S and returns modified state array S′.

Having performed the above calculation for the initial round at step 120 of FIG. 2, the AES encryption algorithm proceeds to step 130a where the algorithm processes the state array for each of a plurality of rounds whilst round<N_{R}. For each round of the AES encryption algorithm, four steps are performed as illustrated in FIG. 2. Specifically, in each round a function SubBytes( ) is performed at step 210, a function ShiftRows( ) is performed at step 220, a function MixColumns( ) is performed at step 230, and the function AddRoundKey( ) is performed at step 240. In the above-described prior implementation, a new instruction must be issued for each round where an operation in the form of a round key for that instruction may be fetched.

SubBytes( )

At step 210 of the AES encryption algorithm, a SubBytes( ) transformation is performed in which a non-linear byte substitution operates independently on each byte of the state array using a substitution table referred to as an SBox. For each byte, the multiplicative inverse in the finite field GF(2⁸) is obtained and the results are transformed using an Affine transformation.

ShiftRows( )

The ShiftRows( ) transformation of step 220 is configured to receive the values of the state array and perform a transformation of those values. In the ShiftRows( ) function, each of the last three rows of the state array are shifted by a different number of bytes, referred to as offsets. The shifting is cyclical such that elements of the state array that are shifted out of the array are brought back into the array at the back (right end). The first row is not shifted. The second row is shifted to the left by a single byte, the third row is shifted to the left by two bytes, and the third row is shifted to the left by three bytes. An example of this shifting is illustrated in FIG. 4. The ShiftRows( ) function therefore receives state array S and returns modified state array S′.

MixColumns( )

Having completed the ShiftRows( ) function at step 220, the AES encryption algorithm proceeds to step 230 where the MixColumns( ) function is performed. The MixColumns( ) function is configured to receive the state array and to perform a transformation of each column of the state array, where each column is treated as a four-term polynomial over GF(2⁸) and multiplied module x⁴+1 with a fixed polynomial a(x), given by:

a(x)={03}x³+{01}x²+{01}x+{02}

As a result of the multiplication, each byte in a particular column of the state array is arranged as set out below, which can be seen in further with respect to FIG. 5:

s′_{0,c}=({02}•s_{0,c})⊕({03}•s_{1,c})⊕s_{2,c}⊕s_{3,c}

s′_{1,c}=s_{0,c}({02}•s_{1,c})⊕({03}•s_{2,c})⊕s_{3,c}

s′_{2,c}=s_{0,c}⊕s_{1,c}⊕({02}•s_{2,c})⊕({03}•s_{3,c})

s′_{3,c}=({03}•s_{s,c})⊕s_{1,c}⊕s_{2,c}⊕({02}•s_{3,c})

The MixColumns( ) function therefore receives state array S and returns modified state array S′.

AddRoundKey( )—Intermediate Rounds

Having completed the MixColumns( ) function at step 230, the AES encryption algorithm proceeds to step 240 where the AddRoundKey( ) function is performed. The AddRoundKey( ) function that is performed at step 240 is similar to the function that is performed at step 120, except that different key values are used. Instead of adding the initial round key of four words w[0, 3] to the state array (as in the initial round), a round key dependent upon the round number, round, is used to transform the columns of the state. Specifically, in this prior implementation the round key is formed of four words that are each retrieved from memory and applied to a separate column of the state by issuing a new instruction to the CPU. The round key is a key that is used specifically for a round that is being performed. Put another way, for each round number round of the total number of rounds N_{R} a different round key is used to perform the AddRoundKey( ) transformation. For a particular round number round, where 1≦round<N_{R}, a portion of the key schedule w[4*round+c] for 0≦c≦4 is used.

Having completed the AddRoundKey( ) function 240 for a particular intermediate round, the intermediate round is complete and the round number round is incremented. At step 140, a comparison is performed between the round number round and the total number of rounds N_{R} to be performed for the AES encryption algorithm. In the event that the currently complete round is not the final iteration of intermediate rounds to be performed, it is determined that the intermediate rounds are not complete. In this event, the AES encryption algorithm proceeds to step 210 and a further intermediate round 130a is performed based upon the incremented round number, round. In the event that the previously completed intermediate round is determined to be the final intermediate round to be performed, as specified in the AES standard, the AES encryption algorithm proceeds to step 150 in which a final round is performed to generate the ciphertext.

Final Round

The final round performed for AES encryption involves the operation of three of the functions previously described. Specifically, the previously described functions SubBytes( ) and ShiftRows( ) are performed upon the state array. In addition, in the final round, the above-described AddRoundKey( ) function is performed based upon a final round key. The final round key for encryption is formed of the final four words of the generated key schedule, namely the elements of the key schedule w at locations (N_{R}*4) to ((N_{R}*+3). The final round key is also provided as an operand with another instruction to perform the final round. Having performed the SubBytes( ) ShiftRows( ) and AddRoundKey( ) functions in the final round, the values of the state array are output as the encrypted ciphertext.

As will be noted from the encryption algorithm set out above, the key schedule is generated in advance and the specific round key required for each round is read for the entire key schedule.

Hardware for End-to-End AES Processing

Set out below are example methods and apparatuses according to the present disclosure in which the problems set out above are overcome. The methods and apparatuses described below follow the corresponding steps of FIG. 2, with the additional capability of calculating the values of the round key to use in the processing of the subsequent round.

Hardware Implementation—Encryption

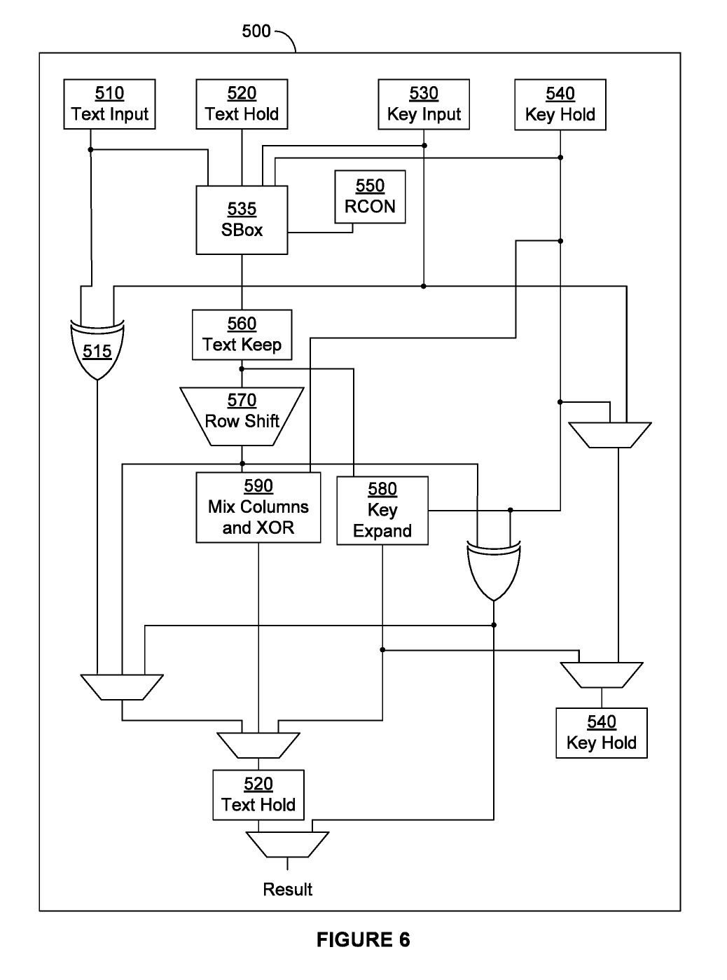

FIGS. 6 to 10 illustrate hardware logic 500 configured to perform one or both of AES encryption or decryption which can form part of an AES encryption and/or decryption instruction execution module. As can be seen in FIGS. 6 to 10, the hardware implementation 500 comprises digital logic that comprises five registers configured to store text and key data, namely a Text Input register 510, a Text Hold register 520, a Key Input register 530, a Key Hold register 540, and a Text Keep register 560. The hardware implementation 500 also comprises a number of modules that are configured to perform specific functions as will be described herein. The registers described above may be implemented as a plurality of flip-flops configured to store intermediate values. The Text Hold register 520 and the Key Hold register 540 at the bottom of FIGS. 6 to 10 are the same Text Hold register 520 and Key Hold register 540 at the top of the same Figures. These registers are illustrated twice for the sake of clarity.

The hardware implementation 500 further comprises an SBox module 535 configured to provide the SBox transformation as described above with reference to the SubBytes( ) and SubWord( ) functions. The hardware implementation 500 also comprises a Row Shift multiplexer 570 configured to perform the ShiftRows( ) function described above, a Mix Columns and XOR module 590 configured to perform the MixColumns( ) and AddRoundKey( ) functions described above. The digital logic 500 also comprises an RCON module 550 configured to store and provide an RCON value in accordance with the AES standard.

The hardware implementation 500 illustrated in FIG. 6 can be configured to implement end-to-end AES encryption based on received initial message data and the initial key data without having to receive a further instruction and without the need to receive any further key data. For encryption, the initial key data may consist of the round key for the initial round, e.g. the original cipher key. The initial message data may be the message text to be encrypted. The hardware implementation of FIG. 6 is configured so that, for each round of the AES algorithm, two passes through the hardware implementation 500 are performed. Each pass through the hardware implementation 500 may be considered to be a stage of processing of a round, namely a first stage and a second stage. Each of the first stage and the second stage may require a single processor cycle to process and thus the execution of a round of the AES encryption algorithm may require two processor cycles to perform. Depending on the clock rate, the two stages may be implemented in more than two clocks.

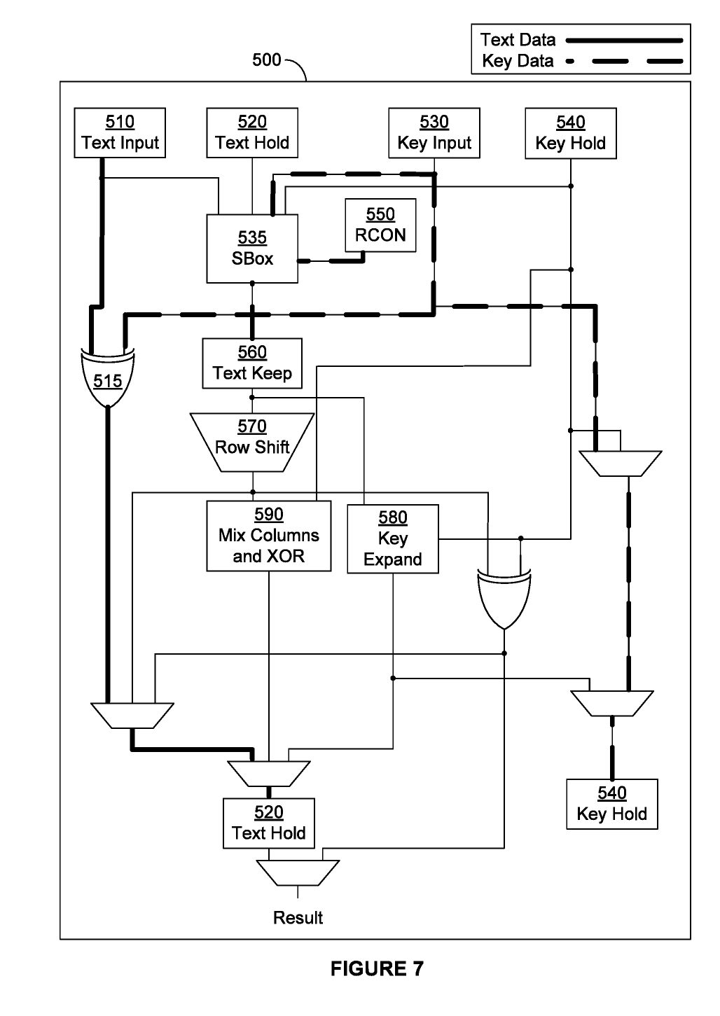

The hardware implementation 500 is configured to partially overlap the processing of data and the generation of key values using key expansion so that the generation of a round key for a subsequent round can be initiated in parallel with the processing of data in the current round. This advantageously makes use of portions of the digital logic of the hardware implementation 500 that is not being used for the processing of data in the current round, thereby improving efficiency in the power consumed and the latency of the system. The behaviour of the hardware implementation 500 will be described below with reference to FIGS. 7 through 10.

Hardware Implementation—Initial Round for Encryption

The performance of the initial round of AES encryption will be described below with reference to FIG. 7 based upon the hardware implementation 500 of FIG. 6. Dark, thick solid lines in FIG. 7 indicate message data flow (i.e. the flow of the processed state array values) through the hardware implementation and key data flow through the hardware implementation is illustrated with a dashed line.

For the initial round, the hardware implementation 500 is configured to receive an initial set of data and an initial cipher key. The initial message data is the message data to be encrypted, in the form of 16 bytes of data which is stored in the Text Input register 510. The initial cipher key for encryption, which in prior implementations would be obtained from the first four words of the key schedule stored in memory, is input and stored in the Key Input register 530. The length of the initial cipher key will depend upon the specific AES implementation, as described above.

For encryption, the initial round involves the performance of the AddRoundKey( ) function to generate new values for the state array, which involves XOR'ing the values of the state array (i.e. the values stored in the Text Input register 510) with the values of initial cipher key (i.e. the values stored in the Key Input register 530). FIG. 7 illustrates the implementation of the initial round of the AES encryption algorithm using XOR gate 515 which is configured to receive the values of the Text Input register 510 and the Key Input register 530. The output of the XOR gate 515 is passed to the Text Hold register 520 and the output forms the values of the state array to be processed in the first intermediate round. The Text Hold register 520 is therefore configured to store 16 bytes of data.

In the examples described herein, the key schedule is not pre-generated and, instead, round keys are generated on-the-fly. It is not necessary to generate a round key for the initial round since the key used in the initial round is the initial cipher key which is provided as an input to the Text Input register 510. However, the subsequent round (the first intermediate round) will require the generation of a new round key via key expansion. In prior systems, the round key for the first intermediate round would be provided by a subsequently issued instruction and would be taken from the wholly generated key schedule stored in memory.

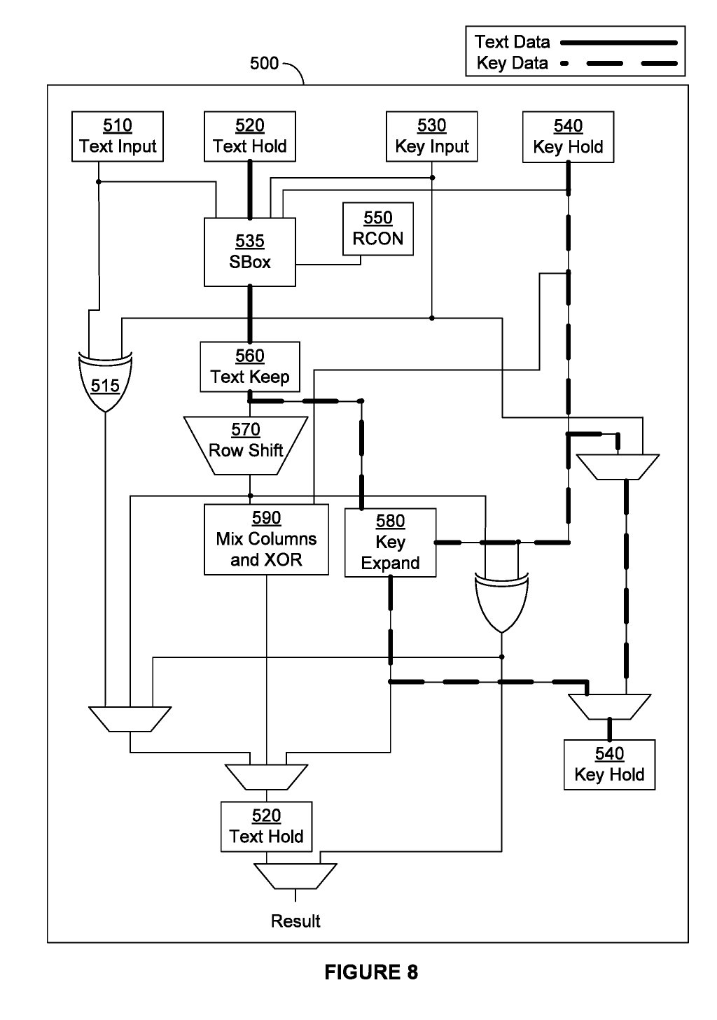

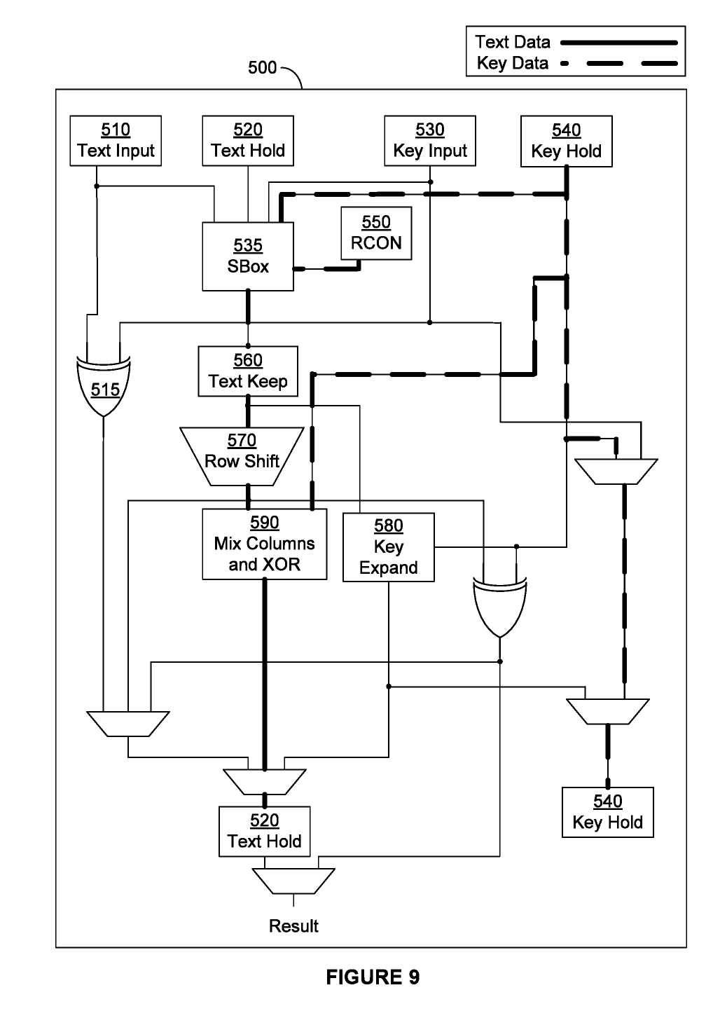

In the initial round of the example hardware implementation described with reference to FIG. 7, the digital logic 500 is configured to initiate the generation of the round key for the subsequent round, which is the first intermediate round. As shown in FIG. 7, the initial cipher key (i.e. the round key for the initial round) is stored in the Key Input register 530 and is passed to the SBox module 535 in which the SubWord( ) function is performed on four bytes of the initial cipher key. The SubWord( ) function forms a part of the key expansion algorithm described above and therefore a portion of the key expansion process is performed during the initial round to initiate the generation of the round key for the subsequent round. The output of the SBox module forms a partial value of the new round key that is stored in the Text Keep register 560. This partial value stored in the Text Keep register 560 is used in the processing of the subsequent intermediate rounds described below in order to generate the round key for the intermediate round. This will be described in more detail below with reference to FIGS. 8 and 9.

In the initial round, the initial cipher key that was initially stored in the Key Input register 530 is passed to the Key Hold register 540 where it is stored for use in subsequent rounds as will be made clear from the following description of the intermediate rounds.

Hardware Implementation—Intermediate Round for Encryption

FIGS. 8 and 9 respectively illustrate first and second stages of a two stage process for executing each intermediate round of AES encryption. In the example of FIGS. 8 and 9, the flow of message text data through the hardware implementation 500 is illustrated by a dark solid line and the flow of key data through the hardware implementation 500 is illustrated by a dashed line. In the example of FIGS. 8 and 9, each stage may take a single processor cycle to perform and thus the performance of a single intermediate round may require at least two processor cycles.

At the beginning of the processing of a first stage of a current intermediate round, the round key that was used to process the state array in the previous round is stored in the Key Hold register 540 and the values of the state array are stored in the Text Hold register 520. In the first stage of the processing for an intermediate round, the state array is passed from the Text Hold register 520 through the SBox module 535 and then stored in the Text Keep register 560. In the SBox module 535, an SBox transformation is performed on all 16 bytes of the state in order to implement the SubBytes( ) function.

Also in the first stage, the partially processed round key for the current round that is stored in the Text Keep register 560 is passed to the Key Expand module 580. The output from the Text Keep register 560 is generated in the previous clock cycle as part of the processing of the previous round and comprises values derived from the previous round key that has been processed by the SBox module 535 according to the SubWord( ) function. Where the intermediate round currently being processed is a first intermediate round, the values stored in the Text Keep register 560 are the initial cipher key values that have undergone processing according to the SubWord( ) function as described previously with reference to FIG. 7. For other intermediate rounds, the values stored in the Text Keep register 560 are the previous round key values that have undergone processing according to the SubWord( ) function.

The output from the Text Keep register 560 in the first stage of the intermediate round is passed to the Key Expand module 580. The Key Expand module 580 is configured to receive the processed key data from the Text Keep module 560 and the previous round key from the Key Hold module 540. The Key Expand module 580 is configured to calculate the round key to be used in the current intermediate round. The values stored in the Key Hold register 540 are updated to contain the processed data according to the output from the Key Expand module 580, such that the Key Hold register 540 stores the round key to be used in processing the state array using the AddRoundKey( ) function in the current intermediate round.

FIG. 9 illustrates a second stage of processing a current intermediate round of the AES encryption algorithm using hardware implementation 500. Dark solid lines indicate state array data flow and dashed lines indicate the key data flow through digital logic 500. As described above, at the end of the first round, the Text Keep register 560 stores the values of the state array that have been processed according to the SubBytes( ) function and the Key Hold register 540 stores the round key for the current intermediate round.

The output of the Text Keep register 560 is passed to the Row Shift multiplexer 570 in which the ShiftRows( ) function is performed. The data output from the ShiftRows( ) function is passed to the Mix Columns and XOR module 590, which is also configured to receive the round key for the current intermediate round from the Key Hold register 540. The Mix Columns and XOR module 590 is configured to receive the message text data from the Row Shift Module 590 and the round key and to perform both the MixColumns( ) and AddRoundKey( ) functions. The output of the Mix Columns and XOR function is then passed to the Text Hold register 520. The values stored in the Text Hold register are the processed state array values generated for the intermediate round.

For the key data path through hardware implementation 500, the key data stored in the Key Hold register 540 is passed to the SBox module 535 which performs the SubBytes( ) function on four bytes and stores the resultant value in the Text Keep register 520 as part of the process of generating the round key for the subsequent round. The round key is also passed back to the Key Hold register 540 for use in a subsequent round. For key expansion, only four bytes of key data need be transformed at a time, such that the other 12 SBoxes (in a 16 SBox arrangement) are not used. In one of the unused SBoxes, the RCON value may be selected to be passed to the next stage where it is needed in key expansion performed by the Key Expand module 580

Hardware Implementation—Final Round for Encryption

As described previously, the final round of the AES encryption algorithm is similar to the intermediate rounds but differs in that the function MixColumns( ) is not performed. The first stage of a final round is handled in the same manner as the first stage of an intermediate round. Specifically, in the first stage of a final round SBox module 535 processes the 16 byte state array values generated during the final intermediate round according to the SubBytes( ) function and stores the processed values in the Text Keep register 560. In parallel with the processing of the state array from the previous round by SBox module 535, the previously processed key data stored in Text Keep register 560 is passed to the Key Expand module 580 so as to generate the round key for the final round, as described above, which is stored in the Key Hold register 540.

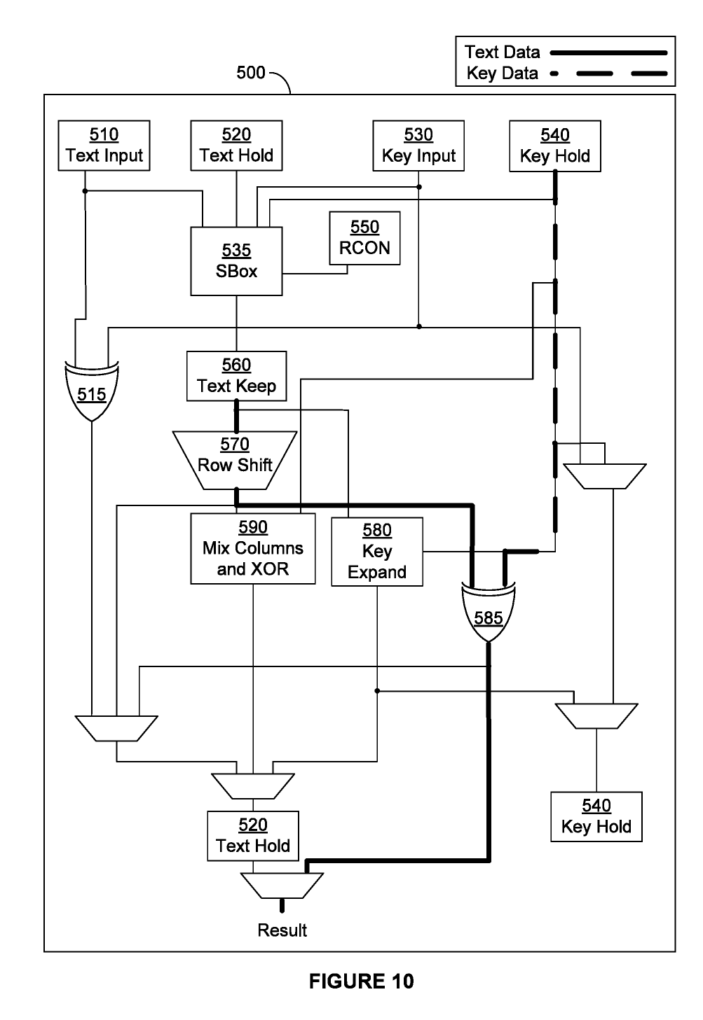

The second stage of a final round is handled differently to the second stage of an intermediate round and is illustrated in FIG. 10. As with the previous Figures, the dark solid lines indicate message text data flow and the dashed lines indicate key data flow. In the second stage of the final round, the output ciphertext is generated based upon the final round key and the state array values stored in Text Keep register 560. In the second stage, the values stored in the Text Keep register 560 are passed to Row Shift multiplexer 570 in which the ShiftRows( ) function is performed. The output of the Row Shift multiplexer 570 is passed to XOR gate 585. XOR gate 585 is also configured to receive the round key for the final round from the Key Hold register 540. Since, in the final round, the MixColumns( ) function is not performed, the output from the Row Shift multiplexer 570 is not passed to the Mix columns and XOR module 590. Instead, the XOR gate 585 is configured to perform the AddRoundKey( ) function in the final round (which is effectively an XOR operation) and to pass the resultant value, which forms the ciphertext of the original message text, to the output via an optional multiplexer. Additional optional multiplexers may be used to store the resultant ciphertext in the Text Hold register 520 so as to introduce a delay of one processor cycle before outputting the result or may be used for selecting partial round functions. The output of the Text Hold register 520 may also be connected (not shown) to the input to the multiplexers so as to enable multiple processor cycles of delay before outputting the result.

By implementing the AES algorithm in this way, it is not necessary to store the entire key schedule at any given moment. Instead, the Key Hold register 540 need only store the key values needed to generate the next round key. In this implementation, the maximum number of key values that need to be stored in any given processor cycle is eight key values (e.g. 8 bytes or 256 bits), as will be described later. It is also only necessary to store the values in the state array. Moreover, a single instruction may be decoded to initiate the performance of the AES encryption algorithm in which only the first round key is provided. It will also be appreciated that the SBox module requires a significant amount of logic to implement and to power. By re-using the logic each processor cycle, an efficient implementation is achieved. Registers sizes can be kept relatively small since they only need to store enough key data to calculate a key for a subsequent processor cycle.

Decryption

The above examples provide detail of the AES encryption algorithm and example approaches for implementing the AES encryption algorithm in hardware. The following description provides detail of the AES decryption algorithm and how the previously described hardware implementation may be used to perform end-to-end decryption on-the-fly.

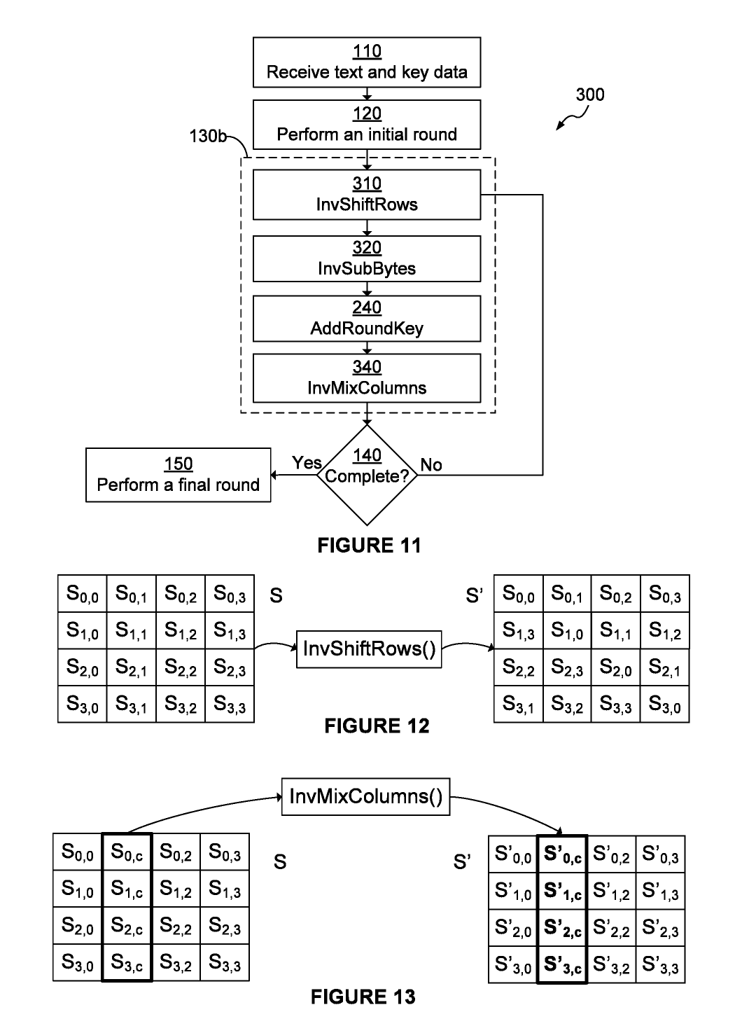

FIG. 11 illustrates an example AES algorithm 300 for performing decryption of ciphertext, which is also illustrated in the following pseudo code:

```
InvCipher(byte in[16], byte out[16], word w[4*(Nr+1)])
begin
    byte state[4,4]
    state = in
    AddRoundKey(state, w[Nr*4, (Nr*4)+3])
    for round = Nr−1 step −1 downto 1
        InvShiftRows(state)
        InvSubBytes(state)
        AddRoundKey(state, w[4*round, (4*round)+3])
        InvMixColumns(state)
    end for
    InvShiftRows(state)
    InvSubBytes(state)
    AddRoundKey(state, w[0, 3])
    out = state
end
```

At step 110 of FIG. 11, the initially received key values (e.g. the initial cipher key) and the ciphertext that is to be decrypted into the original message text is received and the method proceeds to step 120.

In prior approaches, as described above, the key schedule can be pre-generated in its entirety. For AES decryption in the examples described herein, the initial cipher key that is used to perform the AddRoundKey( ) function in the initial round is formed of the round key used in the final round of encryption (e.g. the final values of the key schedule), namely the values defined by w[(N_{R}*4), ((4*N_{R})+3)]. In prior implementations, the entire key schedule is generated as described above. In AES, the round key for the final round of the AES encryption is used as the initial cipher key for AES decryption.

After performing the initial round at step 120 for the initial round of AES decryption, the method 300 proceeds to step 130b in which an intermediate round is processed. An intermediate round 130b comprises four functions that are performed for each intermediate round processed. The four functions are InvShiftRows( ) which is performed at step 310, InvSubBytes( ) which is performed at step 320, AddRoundKey( ) which is performed at step 240, and InvMixColumns( ) which is performed at step 340. The functions InvSubBytes( ) InvShiftRows( ) and InvMixColumns( ) are respectively configured to perform the inverse functions of SubBytes( ), ShiftRows( ) and MixColumns( ) that are performed in the AES encryption algorithm. These will be described in more detail below.

InvShiftRows( )

As described above, the InvShiftRows( ) function performed at step 310 is the inverse of the ShiftRows( ) transformation. The ShiftRows( ) function performs a left cyclic shift of three rows of the state array. In contrast, the InvShiftRows( ) function operates to perform a right shift in the opposing manner to the ShiftRows( ) function.

In the InvShiftRows( ) transformation of step 310, each of the last three rows of the state array are shifted by a different number of bytes, referred to as offsets (as with the ShiftRows( ) function). The first row is not shifted. The shifting is cyclical such that elements of the state array that are shifted out of the array are brought back into the array at the front (left end). The second row is shifted to the right by a single byte, the third row is shifted to the right by two bytes, and the third row is shifted to the right by three bytes. An example of this shifting is illustrated in FIG. 12, in which the InvShiftRows( ) function receives state array S and returns modified state array S′.

InvSubBytes( )

At step 320, the InvSubBytes( ) function is performed on the values of the state array. The InvSubBytes( ) function involves performing the inverse of the byte substitution transformation of the SubBytes( ) function, in which an inverse SBox is applied to each byte of the stage by applying the inverse of an Affine transformation followed by taking the multiplicative inverse in the finite field GF(2⁸).

AddRoundKev( )

Having completed the InvSubBytes( ) function of step 320, the AES decryption algorithm proceeds to step 240 in which the function AddRoundKey( ) is performed.

The AddRoundKey( ) function is the same function for encryption and decryption and differs only in the key values to which the function is applied. For example, the AddRoundKey( ) performed in the initial round of the decryption process utilises key values that are positioned in the last locations of the key schedule. In the first intermediate round, the key values located in the set of locations in memory prior to the key values for the initial round are used. More generally, for each round number, the values of the key schedule w used in the first intermediate round are the values w[round*4] to w[(round+1)*3]. The round number, round, has a starting value of N_{R}-1 and decrements with each round down to 1.

InvMixColumns( )

Having completed step 240, the AES decryption algorithm applies to the values of the state array a InvMixColumns( ) function at step 340. As described above, the InvMixColumns( ) function performs the inverse of the MixColumns( ) function performed by the AES encryption algorithm described above. As with the MixColumns( ) function, InvMixColumns( ) operates on the state array on a column-by-column basis, whereby the function is applied to each column and treats each column as a four-term polynomial over GF(2⁸) and multiplied module x⁴+1 with a fixed polynomial α⁻¹(x), given by:

α⁻¹(x)={0b}x³+{0d}x²+{09}x+{0e}

Each byte in a particular column of the state array is therefore arranged as set out below, which can be seen in further detail with respect to FIG. 11:

s′_{0,c}=({0e}•s_{0,c})⊕({0b}•s_{1,c})⊕({0d}•s_{2,c})⊕({09}•s_{3,c})

s′_{1,c}=({09}•s_{0,c})⊕({0e}•s_{1,c})⊕({0b}•s_{2,c})⊕({0d}•s_{3,c})

s′_{2,c}=({0d}•s_{0,c})⊕({09}•s_{1,c})⊕({0e}•s_{2,c})⊕({0b}•s_{3,c})

s′_{3,c}=({0b}•s_{0,c})⊕({0d}•s_{1,c})⊕({09}•s_{2,c})⊕({0e}•s_{3,c})

The InvMixColumns( ) function therefore receives state array S and returns modified state array s′.

After the InvMixColumns( ) function has been performed for the intermediate round 130b, the round number round is decremented and the algorithm proceeds to step 140 in which it is determined whether or not the correct number of intermediate rounds has been completed. In the event that the algorithm has not yet performed the appropriate number of intermediate rounds, the algorithm returns to step 310 and the InvShiftRows( ) function is performed in the subsequent round. Since the round number round in the decryption algorithm is initiated at N_{R}-1 and the round number is decremented after the performance of each round, at step 140 it is determined whether or not the round number round is decreased to the correct number to proceed to the final round. As described previously, the number of rounds that are appropriate depends upon the length in bits of the initial cipher key.

Final Round

In the final round of the decryption algorithm three functions are performed, namely InvShiftRows( ) InvSubBytes( ) and AddRoundKey( ) The AddRoundKey( ) function operates based upon the first four words of the key schedule, namely words w[0] to w[3] of the key schedule. The AddRoundKey( ) function therefore uses the initial cipher key used in encryption in order to perform the AddRoundKey( ) function, for final decryption.

Hardware Implementation—Decryption

According to the present approaches, hardware logic 600 forming part of an AES encryption and/or decryption instruction execution module illustrated with reference to FIGS. 6 to 10, may alternatively or additionally be configured to implement AES decryption. The hardware implementation 600 may therefore be configured into one of three configurations, namely (i) to perform encryption, (ii) to perform decryption, or (iii) to operate in two different modes, where a first mode is to perform encryption and a second mode is to perform decryption. The mode may be determined based upon control signalling received by the hardware implementation 600. In any of the above configurations, the same modules are used. In configuration (i) the modules will be configured to perform the tasks of encryption. In configuration (ii) the modules will be configured to perform the tasks of decryption. In configuration (iii) the modules will be able to perform the tasks of encryption and decryption, based on the mode of operation. The difference in operation of the hardware implementation between encryption and decryption is the initial message data and initial key data that is used and the functions performed. Specifically, where the hardware implementation 500 is configured to perform AES decryption, the SBox module 535, the Row Shift multiplexer 570, and the Mix Columns and XOR module 590 are reconfigured to perform the InvSubBytes( ) InvShiftRows( ) and InvMixColumns( ) respectively, instead of the SubBytes( ), ShiftRows( ) and MixColumns( ) functions performed for encryption.

Hardware Implementation—Initial Round for Decryption

The operation of the hardware implementation 500 for AES decryption is also illustrated with reference to FIGS. 7 to 10. The interconnections of hardware implementation 500 of FIG. 6 is illustrated with dark solid lines to indicate message data flow (i.e. the flow of the processed state array values) through the digital logic and is illustrated with dashed lines to indicate key data flow through the digital logic.

For the initial round of decryption, the hardware implementation 500 is configured to receive initial ciphertext data values in the form of a 4×4 byte array which forms the state array and an initial cipher key. The initial set of ciphertext data that is the ciphertext data to be decrypted into message text data, in the form of 16 bytes of data which is stored in the Text Input register 510 prior to operation. The initial cipher key for decryption which would otherwise form the final entries in the key schedule (i.e. the round key for the final round of encryption) is input and stored in the Key Input register 530. The length of the initial cipher key will depend upon the specific AES implementation, as described above.

For decryption, the initial round involves the performance of the AddRoundKey( ) function to generate new values for the state array. For the initial round, the AddRoundKey( ) function is performed by XOR'ing the values of the state array (i.e. the values stored in the Text Input register 510) with the key values of the initial cipher key (i.e. the values stored in the Key Input register 530).

FIG. 7 illustrates the implementation of the initial round of the AES decryption algorithm in which the AddRoundKey( ) function is performed. To implement this function, XOR gate 515 receives as inputs the state array values from the Text Input register 510 and the initial key values from the Key Input register 530. The output of the XOR gate 515 is passed to the Text Hold register 520 and forms the text data that is to be processed in the first intermediate round for decryption, as will be described later with reference to FIGS. 8 and 9.

In the initial round of decryption, the hardware implementation 500 is also configured to initiate the generation of the round key for the subsequent round (which is the first intermediate round). As shown in FIG. 7, the initial cipher key stored in the Key Input register 530 is passed to the SBox module 535 in which the SubWord( ) function is performed on the initial cipher key. The SubWord( ) function forms a part of the key expansion process described above and therefore a portion of the key expansion process is performed in the SBox module 535 to initiate the generation of the round key for the subsequent round to generate a partial value.

The partially processed value of the new round key is stored in the Text Keep register 560. This partially processed value stored in the Text Keep register 560 is used in the processing in the first stage of the subsequent intermediate round in order to generate the round key for the subsequent intermediate round. This will be described in more detail below with reference to FIGS. 8 and 9. In the initial round, the initial cipher key that was initially stored in the Key Input register 530 is passed to the Key Hold register 540 where it is stored for use in subsequent rounds.

Hardware Implementation—Intermediate Round for Decryption

FIGS. 8 and 9 respectively illustrate a two-stage process comprising a first stage and a second stage for implementing an intermediate round of the AES decryption algorithm. In the example of FIGS. 8 and 9, the flow of the state array values through the hardware implementation 500 is illustrated by a dark solid line and the flow of key values through the hardware implementation 500 is illustrated by a dashed line. At the beginning of the processing of a first stage of a current intermediate round of decryption, the round key for the previous round is stored in the Key Hold register 540 and the current state array is stored in the Text Hold register 520.

In the example of FIGS. 8 and 9, each stage may take a single processor cycle to perform and thus the performance of a single intermediate round may require at least two processor cycles to process. In the first stage of the processing for an intermediate round, the ciphertext data to be processed in that particular round is passed from the Text Hold register 520 through the SBox module 535 and then stored in the Text Keep register 560. In the SBox module 535, an SBox transformation is performed on all 16 bytes of text data in order to implement the InvSubBytes( ) function. The state array values output from the SBox module 535 as a result of applying the InvSubBytes( ) function is stored in the Text Keep register 560.

Also in the first stage, the output from the Text Keep register 560 is provided to the Key Expand module 580. The output from the Text Keep register 560 is generated in the previous stage as part of the processing of the previous round and comprises values derived from the previous round key that has been processed by the SBox module 535 according to the SubWord( ) function. Where the intermediate round currently being processed is a first intermediate round, the values stored in the Text Keep register 560 are the initial cipher key values that have undergone processing by the SBox module as described previously with reference to FIG. 7. For other intermediate rounds, the values stored in the Text Keep register 560 are the previous round key values that have undergone processing according to the SubWord( ) function.

The output from the Text Keep register 560 in the first stage of the intermediate round is passed to the Key Expand module 580. The Key Expand module 580 is configured to receive the processed key data from the Text Keep module 560 and the previous round key from the Key Hold module 540. The Key Expand module 580 is configured to calculate the round key to be used in the current intermediate round. The value stored in the Key Hold register 540 is then updated to reflect the processed data according to the output from the Key Expand module 580, so that the Key Hold register 540 stores the round key to be used in the current round. The round key for the current round is then used in the second stage of the round (described with reference to FIG. 9 below) to process the state array.

FIG. 9 illustrates the second stage of processing using hardware implementation 500 an intermediate round for decryption. As with other Figures, the dark solid lines indicate the state array values flow and the dashed lines indicate the key data flow. As described above, at the end of the first round, the Text Keep register 560 stores the values of the state that have been processed according to the InvSubBytes( ) function and the Key Hold register 540 stores the round key for the current intermediate round.

The output of the Text Keep register 560 is passed to the Row Shift multiplexer 570 in which the InvShiftRows( ) function is performed. The data output from the InvShiftRows( ) function is passed to the Mix Columns and XOR module 590, which is also configured to receive the round key for the particular round being executed from the Key Hold register 540. The Mix Columns and XOR module 590 is configured to receive the ciphertext data from the Row Shift Module 590 and the round key and to perform both the InvMixColumns( ) and AddRoundKey( ) functions. The output of the Mix Columns and XOR function is then passed to the Text Hold register 520. The values stored in the Text Hold register 520 are the state array values resulting from the processing in the intermediate round which can be used in a subsequent round.

For the key data path through the hardware implementation 500, the key data stored in the Key Hold register 540 is passed to the SBox module 535 which performs the InvSubBytes( ) function on four bytes of key data and stores the resultant value in the Text Keep register 560 as part of the process of generating the round key for the subsequent round. The round key is also passed back to the Key Hold register 540 for use in a subsequent round. For key expansion, only four bytes of key data need be transformed at a time, such that the other 12 SBoxes (in a 16 SBox arrangement) are not used. In one of the unused SBoxes, the RCON value may be selected to be passed to the next stage where it is needed in key expansion performed by the Key Expand module 580.

Hardware Implementation—Final Round for Decryption

The final round for decryption is, like the final round for encryption, processed in two stages. The first stage for decryption is processed in a corresponding manner to a first stage of an intermediate round to generate partially processed text data that is stored in the Text Keep register 560 and to generate the final round key. The partially processed text data stored in the Text Keep register 560 has been processed according to the InvSubBytes( ) function.

In the second stage of the final round, the partially processed text data stored in the Text Keep register 560 is passed through Row Shift multiplexer 570 where the InvShiftRows( ) function is performed. Finally, the resultant text data is XOR'd with the round key for the final round using XOR gate 585 to perform the

AddRoundKey( ) function. The resultant decrypted message text is then passed to the output of logic 500.

For the final round of decryption, the InvShiftRows( ) and the InvSubBytes( ) functions applied to the state array in a different order to that specified in the AES standard. However, provided that the InvSubBytes( ) function is applied to the appropriate values of the state array then the two functions can be applied in a different order. For example, the InvSubBytes( ) function should be applied to values in the state array using an offset that is in accordance with the shifted positions in the state array provided by the InvShiftRows( ) function.

For both encryption and decryption, the hardware implementation is configured to complete, in a first stage of a round the generation of a round key for that round, which was started in the second stage of a previous round. During the first stage of a round, the processing of the state array is also begun. In the second stage of the current round, the generation of a key for a subsequent round is initiated and the processing of the stage for the current round is completed.

SBox Module

The SBox module 535 of hardware implementation 500 may be configured to operate in one of three modes, namely (i) a decryption mode, (ii) an encryption mode, and (iii) a key expansion mode within any given stage of processing. Where the hardware implementation is only configured to implement encryption, the SBox module 535 is only needed to operate in modes (ii) and (iii). Where the hardware implementation is only configured to implement decryption, the SBox module 535 is only needed to operate in modes (i) and (ii). Where the hardware implementation is only configured to implement both of encryption and encryption, the SBox module 535 is configured to operate in modes (i), (ii) and (iii). In the encryption mode, the SBox module 535 is configured to perform the SubBytes( ) function. In the decryption mode, the SBox module 535 is configured to perform the InvSubBytes( ) function as described above. In the key expansion mode, the SBox module 535 is configured to partially generate a round key based upon the previous round key.

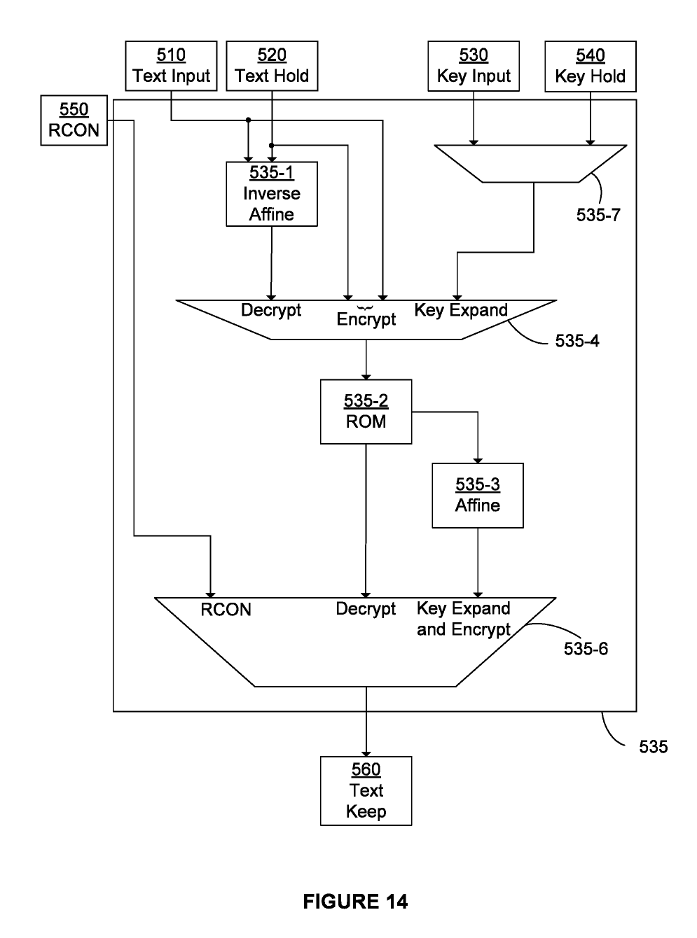

FIG. 14 illustrates an example hardware implementation 535 of an SBox module that can be used in the hardware implementation 500 described previously. The SBox module 535 comprises an Inverse Affine module 535-1, a read-only memory (ROM) 535-2, an Affine module 535-3 and a number of multiplexers 535-4, 535-6, and 535-7.

In the encryption mode, the SBox module 535 is configured to perform the SubBytes( ) function on the state array. As such, in the arrangement of FIG. 14 the SBox module 535 is configured to operate upon the 16 bytes of the state array in parallel. As referred to herein, each operation on a byte can be regarded as a separate SBox. Accordingly, the SBox module 535 of FIG. 14 can be considered to comprise 16 separate SBoxes. For encryption, the SubBytes( ) function may be implemented as the multiplicative inverse in the finite field GF(2⁸) followed by an affine transformation over GF(2). In the present implementation, the values stored in the Text Hold 520 and Text Input 510 registers are passed to to the multiplexer 535-4. When in the encryption mode, the SBox module 535 is configured to select a value from registers 510 and 520 using multiplexer 535-4 and to pass these values to ROM module 535-2, in which a lookup of the multiplicative inverse in the finite field GF(2⁸) is performed based upon the received text data.

Having performed the lookup using ROM 535-2, the resultant values are passed to Affine module 535-3 in which an affine transformation over GF(2) is performed. The values output from the Affine module 535-3 are the values of the state array having been processed according to the SubBytes( ) function. The output from the Affine module 535-3 is passed to multiplexer 535-6 which is configured to select one of three outputs based upon which mode (encryption, decryption, or key expansion) the SBox module is configured to operate. In the encryption mode, the output from the Affine module 535-3 is passed to the Text Keep register 560.

In the key expansion mode, the SBox module 535 is configured to select the Key Expand signals as illustrated for multiplexer 535-4. In addition, the multiplexer 535-7 is configured to select between the Key Input register 530 and the Key Hold register 540. For the first time that key expansion is performed, the key data used to generate the subsequent round key is the key data received from the Key Input register 530. For subsequent key expansions for subsequent rounds, the input selected at multiplexer 535-7 is the input received from Key Hold 540. The key data from the multiplexer 535-7 is passed to multiplexer 535-4 at which it is selected to be passed to ROM 535-2. The multiplexer 535-4 selects the key data from multiplexer 535-7 since the SBox module 535 is operating in the key expansion mode. For key expansion, SubWord( ) function is performed. For the arrangement of FIG. 14, the SubWord( ) function requires two calculations, namely (i) the multiplicative inverse in the finite field GF (2⁸) and then (i) an affine transformation over GF(2). In the key expansion mode the ROM 535-2 is used in the same manner as described above for the encryption mode and Affine module 535-6 is used to apply an affine transformation to the partially processed key data.

In some arrangements, timing issues may arise. Due to the additional multiplexing required for the key data when compared with the text data for the encryption mode, there may not be sufficient time to perform both of the multiplicative inverse and the affine transformation in the same stage (e.g. in the same processor cycle). Instead, a separate Affine transform module may be provided between the SBox module 535 and the Key Expand module 580 for use in the subsequent stage of the processing of a single round for key expansion. Affine module is skipped when performing decryption.

The SBox module 535 is also configured to operate in a decryption mode in which the function InvSubBytes( ) is performed. For decryption, since the multiplicative inverse is the inverse of itself, the InvSubBytes( ) function for decryption is the inverse affine function followed by the same multiplicative inverse as performed for encryption. For decryption, the InvSubBytes( ) function is therefore implemented by including an Inverse Affine module 535-1 that is configured to perform the inverse affine transformation based upon the inputs provided from the Text Input module 510 and the Text Hold module 520.

The result of the inverse affine transformation performed in the Inverse Affine module 535-1 is then passed to multiplexer 535-4 at which the values are selected to be passed to ROM 535-2 based on the SBox module 535 operating in the decryption mode. Similarly, the multiplexer 535-6 is configured to select the output of ROM 535-2 and to pass the values to Text Keep register 560 for use in a second stage of processing a round for decryption, as set out below.

The multiplexers 535-4, 535-6, and 535-7 of SBox module 535 may be configured to select which of the signals to pass based upon control signals implemented in the hardware implementation 500. Specifically, SBox module 535 may operate based upon a control signal indicating which of encryption, decryption, and key expansion is to be performed for a particular stage. Thus, for a particular intermediate round for encryption, the SBox module 535 may be configured in the encryption mode for a first stage and in the key expansion mode for a second stage. Similarly, for a particular intermediate round for decryption, the SBox module 535 may be configured in the decryption mode for a first stage and in the key expansion mode for a second stage. In the examples provided, each stage may take a single processor cycle to perform the calculations and to pass the result to the Text Keep register 560.

Key Expand Module

Using the hardware implementation 500 set out above for encryption and decryption, the key expansion is separated into two steps that are performed in consecutive stages. The Key Expand module 580 is configured to perform a second step of the key expansion process in which the round key for use in the next round of either encryption or decryption is performed.

As described above, the AES standard allows for a number of different key sizes to be used to perform encryption or decryption whilst the text (ciphertext or message text) is always the same size. As such, different logic may be required to implement “on-the-fly” key expansion for each of AES128, AES192, and AES256 and the manner in which these key values are generated may differ for encryption and decryption. As such, the Key Expand module 580 is configured to operate in one of six modes, namely AES128 encryption, AES128 decryption, AES192 encryption, AES192 decryption, AES256 encryption, and AES256 encryption.

AES128 Key Expansion

Encryption

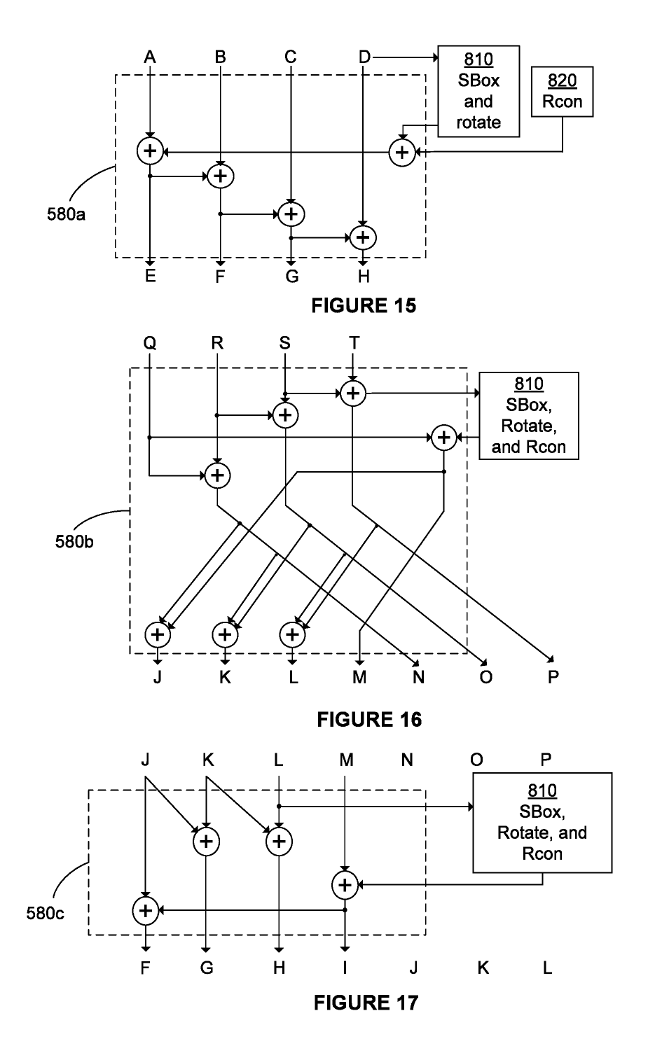

Example logic circuitry 580a for implementing the AES128 key expansion for encryption in the Key Expand module 580 is illustrated in FIG. 15. In general, key expansion for AES128 is performed by generating four key words (16 bytes) from four previous key words that form the mostly recently expanded key words. For example, the four key words may be the four key words generated for use in performing AddRoundKey( ) in the previous round.

In the example of FIG. 15, the four key words that were previously generated through key expansion (and were stored in the Key Hold register from the previous round) are labelled A. B, C, and D, where the first key value is A and the fourth key value is D. The result of key expansion according to AES128 is that the next four key values, which form the round key for use in the next round, are generated from the previous round key. As can be seen from FIG. 15, the key expansion procedure firstly comprises applying an SBox and rotate function 810 to the fourth key word D, and retrieving an Rcon value (for example from a memory 820) and passing the result to the Key Expand module 580. The rotate function performs a rotation of the four bytes comprising the word, such that the first byte becomes the last byte in accordance with performing the shift of the second row of the ShiftRows( ) function. These steps may be considered to be the first stage of key expansion and are illustrated together by reference numerals 810 and 829. The Key Expand module 580 is configured to receive the result of applying the SBox and rotate 810 results, the Rcon value 820, and values A, B, C, and D. The Key Expand module 580a is then configured to perform a series of XOR operations to the inputs as illustrated in FIG. 15 in order to produce the next four key values E, F, G, and H.

The output of the SBox and rotate function 810 is XOR'd with a retrieve Rcon value. The result of this XOR calculation is then used as an input to a further XOR gate, which also receives as an input key value A. The result of this XOR is passed to output E and forms the first key value of the sequence of key values which form the subsequent round key. The value that is passed to output E is also fed into an XOR gate along with input B and the result of this XOR calculation is passed to output F. The value at output F is passed to another XOR gate that also receives an input C. The result of this XOR calculation is passed to output G. The value at output G is passed to another XOR gate that also receives an input D. This XOR gate generates output H. For a subsequent round of key expansion for encryption, the generated key values E, F, G, and H are used as the input key values to the Key Expand module 580, to generate key values I, J, K, and L which are effectively the next four values in the key schedule.

Decryption

A configuration of a Key Expand module 580 for AES128 decryption is illustrated in FIGS. 16 and 17. The logic circuitry 580b of the Key Expand module 580 illustrated in FIG. 16 is configured to perform an initial round of key expansion for AES128 decryption. In this arrangement, the Key Expand module 580a is configured to receive first to fourth key values Q, R, S, and T which form the round key for the initial round (and the round key for the corresponding final round of encryption) and to generate round key values used for subsequent round keys. In the example of FIG. 16, seven key values J, K, L, M, N, and P are generated. The seven generated key values would effectively form seven values in a key schedule with positions in the key schedule located prior to the input key values, i.e. would form key values prior to key values Q, R, S, and T. In this arrangement, XOR operations are performed and the results are passed to module 810 in which an SBox transformation, a rotate operations, and the application of an Rcon is performed.

FIG. 17 illustrates a process of key expansion in subsequent rounds that follows the key expansion performed in FIG. 16 using logic circuitry 580c. Following the initial round of key expansion, four of the key values are used to generate a further four key values as shown in FIG. 17. Specifically, key values J, K, L, and M are used to generate key values F, G, H, and I, where the key values F, G, H, and I represent key values located in the key schedule prior to the key values J, K, L, and M. For a subsequent round of key expansion for decryption, the key values F, G, H, I, J, K and L would be used to provide key values B, C, D, and E which effectively form the previous four key values of the key schedule.

AES256 Key Expansion

In AES 256 “on-the-fly” key expansion, four key words are generated and used each round. AES256 key expansion differs from AES128 key expansion in that the previous eight key values (key words) are used to generate the next four key values in the key schedule. The previous eight key values therefore need to be stored in the Key Hold register 540.

Encryption

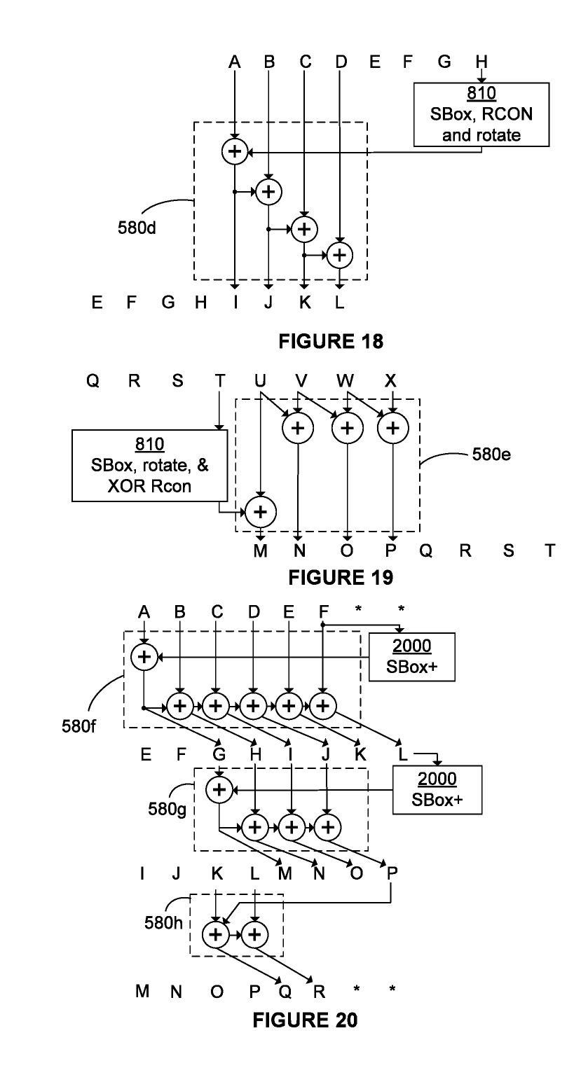

Example digital circuitry 580d for use in a Key Expand module 580 to implement AES256 key expansion for encryption is illustrated in FIG. 18. In this arrangement A, B, C, D, E, F, G, and H represent the eight most recently expanded key words. From these values, the next four expanded key values I, J, K, and L are computed. The values E, F, G, and H can be copied to the associated output values such that key values E, F, G, H, I, J, K, and L are stored in the Key Hold register 540. For a subsequent round of key expansion for encryption, the key values E, F, G, H, I, J, K, and L may be used to generate four new key values M, N, O, and P as well as to copy the key values I, J, K, and L to the output such that key values I, J, K, L, M, N, O, and P are stored in the Key Hold register 540.

Decryption

An example implementation of digital circuitry 580e implemented in a Key Expand module 580 for AES256 decryption is illustrated with reference to FIG. 19. As can be seen in FIG. 19, the Key Expand module 580 is configured to receive eight key values, namely Q, R, S, T, U, V, W, and X. These eight key values are then used to generate four key values, namely key values M, N, O, and P. The key values Q, R, S, and T are also copied to the output and may be stored in the Key Hold register. The key values M, N, O, P represent the values in the key schedule that appear before the key values Q, R, S, T, U, V, W, and X in the key schedule. In a subsequent round of key expansion for decryption, the input values are M, N, O, P, Q, R, S, and T and the output values are I, J, K, L, M, N, O, and P, where key values I, J, K, and L represent the next key values to be used for decryption.

For key expansion for both AES256 encryption and decryption, the operation varies for every other pass through the Key Expand module 580. Specifically, in a pass the RCON values and a rotate is performed. In an alternate pass, the RCON value is zero and a row shift is not performed.

AES192 Key Expansion

Encryption

“On-the-fly” key expansion for AES192 is more complex than for AES128 and AES256 since, for AES192, key expansion occurs for six key values (key words) at a time but the encryption algorithm functions at four words per round. As a result, key expansion for AES192 as described herein comprises three separate key expansion circuits that are used in sequence to perform key expansion.

FIG. 20 illustrates example circuitry 580f, 580g, 580h for performing AES192 key expansion for encryption. A single set of circuitry (e.g. one of 580f, 580g, 580h) may be re-used for each round of key generation. Since N_{K}=6 for AES192, the number of input key words is 6, which in the example of FIG. 20 are illustrated as A, B, C, D, E, and F. The Sbox+ module 2000 illustrates the combined SBox, rotate and Rcon operations described previously and are combined into a single module for the sake of clarity. The arrangement of FIG. 20 illustrates digital circuitry that represents behaviour across three separate rounds.

In a first round of key expansion, six key values A, B, C, D, E, and F are used to generate six new values, namely G, H, I, J, K, and L. These six values, along with two of the previous key values E and F may be stored back to the Key Hold register. In a next round of key expansion, four new key values M, N, O, and P are generated and stored in the Key Hold register along with previously generated key values I, J, K, and L. In a third round of key expansion the next two key values Q and R are generated and may be stored in the Key Hold register along with the previously generated key values M and N. After the third round of key expansion, six key values may be stored in the Key Hold register. These six key values (M, N, O, P, Q, and R) may then be used for a subsequent round in accordance with the above-described first round of key expansion using the circuit of FIG. 20. Put another way, the above three stages may be repeated with key values M, N, O, P, Q, and R used in place of key values A, B, C, D, E, and F.

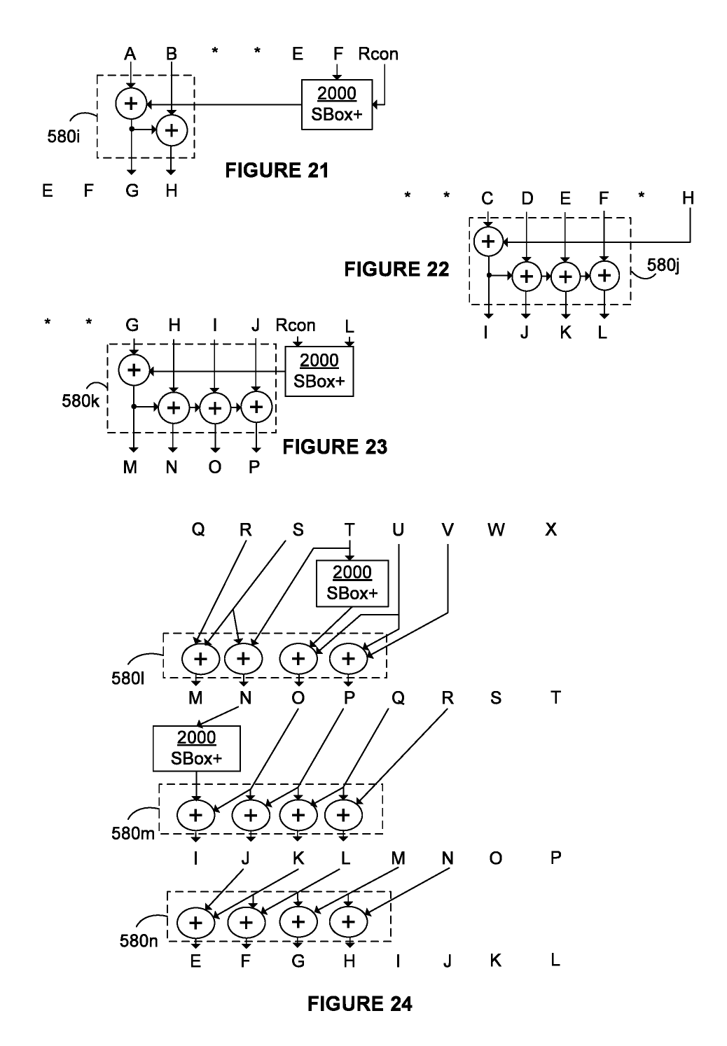

FIGS. 21 to 23 also illustrate three separate circuits 580i, 580j, and 580k which may be used to generate key values for AES192 key generation for encryption. Specifically, in a first stage, the circuit of FIG. 21 may be used in which the key values A, B, C, D, E, and F are used to generate key values G and H. The key values B, C, D, E, F, G, and H and then stored in the Key Hold register. In a subsequent stage, the circuit of FIG. 22 may be used to generated, from key values C, D, E, F, G, and H, four new key values I, J, K, and L. The key values E, F, G, H, I, J, K, and L are stored in the Key Hold register. In a subsequent stage, the circuit of FIG. 23 is used to generate four new key values M, N, O, and P.

Accordingly, key values I, J, K, L, M, N, O, and P are stored in the Key Hold register. In a subsequent stage, the circuit of FIG. 22 is again used to generate four new key values Q, R, S, and T. The key values M, N, O, P, Q, R, S, and T are then stored in the Key Hold register.

By performing these four stages, twelve new key values are generated from the originally stored key values. Each round, key values are consumed (i.e. applied to the state) and new values are generated. For this arrangement, four stages are needed to generate twelve new key values and each processor cycle four key values are used as part of the algorithm.

Decryption

As with AES192 “on-the-fly” expansion for encryption, the AES192 “on-the-fly” expansion for decryption is configured for three rounds as set out in FIG. 24 using logic circuits 580l, 580m, 580n. A single set of circuitry (e.g. one of 580l, 580m, 580n) may be re-used for each round of key generation. The initially input cipher key will comprise eight key words, namely Q to X. In the first round, key values M, N, O, and P are generated and stored in the Key Hold register along with previously generated key values U to X. In the subsequent round, key values 1 to L are generated and stored in the Key Hold register along with the key values M to P generated in the previous round. In the third round, the key values E to H are generated and stored in the Key Hold register along with the previously generated key values 1 to L.

The above approaches for performing key expansion for AES128, AES256, and AES192 are examples of partitioning the key values so as to perform key expansion. In other arrangements, it will be appreciated that additional key values may be generated in different ways. For example, it may be possible to generate more key values in a single pass of the Key Expand module 580 by including additional logic. It will be appreciated that the number of key values that are to be generated in a pass will affect the amount of logic needed to implement the Key Expand module 580 and the amount of time within a processor cycle needed to perform the key expansion. In addition, larger registers would be required to store the generated key values.

Increased Throughput

In FIGS. 6 to 10, hardware logic is presented in which a single round of AES encryption or decryption, including the required key expansion for that round, may be performed every two processor cycles. The example arrangement of FIGS. 6 to 10 may utilise 16 SBoxes to implement the SBox module 535 since it is required to operate upon each byte of the state array in parallel. As such, the arrangement of FIGS. 6 to 10 is capable of a throughput of one round every two stages (e.g. every two processor cycles).

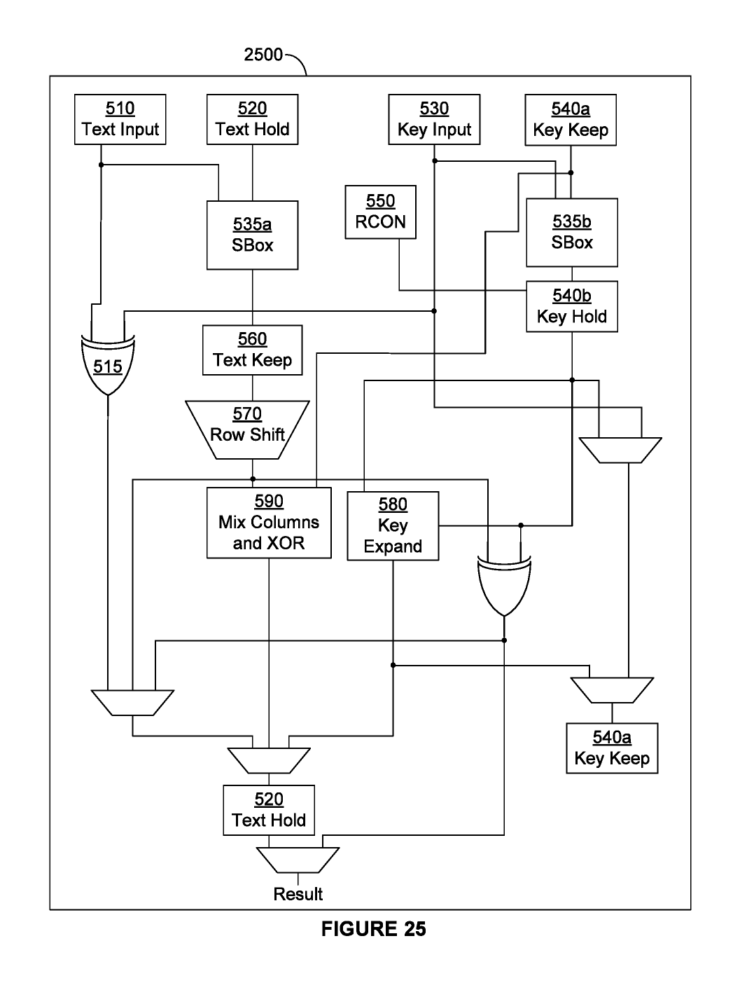

With a modification to the hardware logic set out in FIGS. 6 to 10 it is possible to significantly increase the data throughput of the hardware implementation. A further implementation of hardware logic forming part of an AES encryption and/or decryption instruction execution module is described below which provides the improved data throughput is set out below with reference to FIGS. 25 to 29. In this arrangement, an additional SBox module 535b comprising a further set of SBoxes, for example four SBoxes, is added along with an additional register Key Keep 540a. By adding these additional components, a different hardware implementation 2500 can be generated in which only paths from ‘hold’ registers to ‘keep’ registers are used in a first stage of a round and only paths from ‘keep’ registers to ‘hold’ registers are used in a second stage of the round. Since the other of the paths is unused in a particular stage of processing a round, it is possible to simultaneously process two separate decryption or encryption requests.

For example, in a first stage of a round, key data for a first decryption or encryption method may be processed between the Key Keep register 540a and the Key Hold Register 540b. In a first stage of the same round, text data for a first decryption or encryption method may be processed between the Text Keep register 560 and the Text Hold register 520. Simultaneously, during the first stage of the same round, key data for a second, separate decryption or encryption method may be processed between the Key Hold Register 540b and the Key Keep register 540a. Text data for the second decryption or encryption method may be processed during the first stage of the round between the Text Hold register 520 and the Text Keep register 560.

The first encryption or decryption method is operating using a first “section” of the hardware implementation 2500 during a first stage and the second encryption or decryption method is operating using a second “section” of the hardware implementation 2500 during the first stage. In the second stage, the first encryption or decryption method operates using the second “section” and the second encryption or decryption method. The latency in performing encryption or decryption is unaffected (e.g. two processor cycles may still be required to process a round of encryption or decryption for a particular method), but the throughput of the hardware implementation 2500 is effectively doubled since it is possible to process first and second encryption or decryption methods simultaneously.

In this arrangement, SBox module 535a only executes the SubBytes( ) function for encryption and decryption, so it does not contain key inputs from 530 and 540, does not contain multiplexer 535-7 shown in FIG. 14, and does not contain the RCON path. SBox module 535b is used only for key expansion, so it does not contain text inputs from 510 and 520, and does not contain the inverse affine module 525-1 shown in FIG. 14. Further, the data in the ROM of the SBox module 535b may be modified to provide the result of the combined multiplicative inverse in GF(2⁸) since followed by the affine transformation. Since these two functions will always be performed for key expansion, the two functions may be combined into a single process involving a lookup from a ROM 535-2 that stores values relating to the application of the combination of these two functions. Thus SBox module 535b may only include multiplexer 535-7 and ROM 535-2 from FIG. 14. In the arrangement set out herein, the RCON value is provided by an RCON module 550 which is directly connected to the Key Hold register 540b. Since all of the SBoxes are in used during every stage of processing, the RCON value must be provided separately and can be stored in the Key Hold register 540b and passed to the Key Expand module 580 with the key data when used for key expansion.

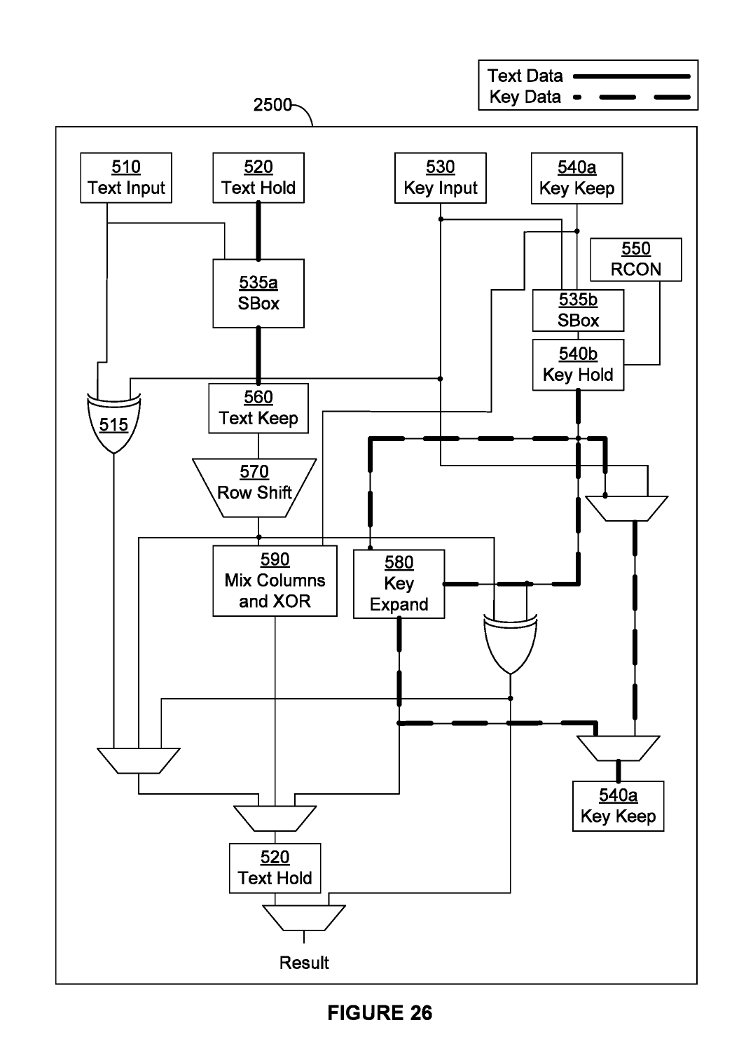

FIG. 26 illustrates a first stage of a round for encryption or decryption. In the arrangement of FIG. 26, a stage of a round of encryption or decryption is performed according to a first method of encryption or decryption. In FIG. 26, the dark solid line represents the flow of state array data through the hardware implementation 2500 and the dashed lines represent key data flow through the hardware implementation 2500. In a similar manner to the approach of FIGS. 6 to 10, in the first stage of processing text data to be processed in the round is processed by SBox module 535a. The processed text data output from SBox module 535a is then stored in the Text Keep register 560. In parallel, key data stored in Key Hold register 540b is passed to the Key Expand module 580.

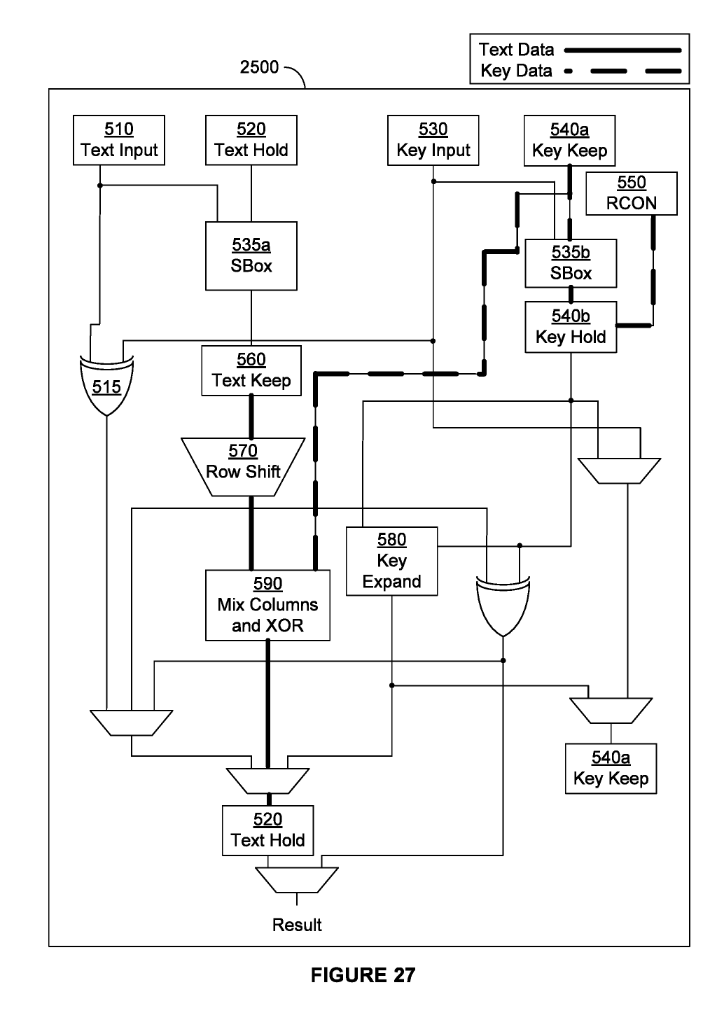

The key data stored in the Key Hold register prior to executing the first stage of a round can be considered to be equivalent to the key data processed in the second stage of the arrangement of FIGS. 6 to 10 and stored in the Text Keep register 560 and then retrieved from the register at the beginning of the first stage of the arrangement of FIGS. 6 to 10. Put another way, the processing of key data in SBox module 535 in the second stage of the arrangement of FIGS. 6 to 10 is, in the arrangement of FIG. 26, performed in an additional SBox module 535b and instead stored in Key Hold register 540b in the second stage for retrieval in the first stage as illustrated in FIG. 27 described in more detail below. SBox 535b is configured to process key data stored in the Key Keep register 540a to generate four new key values. The SBox module 535b is therefore configured to generated four key values in parallel and therefore can be considered to comprise four SBoxes.

In the arrangement of FIG. 26, the key data retrieved from Key Hold register 540 is passed to the Key Expand module 580 and the key data is processed as described in a corresponding manner as described above with reference to FIGS. 6 and 10. The round key to be used in the second stage of the processing of the current round is generated and stored in Key Keep register 540a.

FIG. 27 illustrates a second stage of processing a round. As with FIG. 26, the dark solid lines represent the flow of state array data through hardware implementation 2500 and the dashed lines represent the flow of key data through hardware implementation 2500. In the second stage illustrated in FIG. 27, the text data stored in the Text Keep register 560 has been processed by SBox Module 535a. The text data stored in the Text Keep register 560 is passed to the Row Shift multiplexer 570 in which the ShiftRows( ) function is performed in a corresponding manner to that described above with reference to FIGS. 6 to 10. The result of this calculation is then passed to the Mix Columns and XOR module 590 which is configured to also receive the round key for the particular round being processed. The processed state array data for that round is generated by the Mix Columns and XOR function 590 and passed to Text Hold register 520. In parallel, the round key for the current round is passed to the SBox module 535b and the round key is partially processed and then stored in Key Hold register 540b. As previously discussed, the processing of the round key for the current round by SBox module 535b corresponds to the processing performed by the SBox module 535 with reference to FIGS. 6 to 10. SBox module 535b used in the arrangement of FIGS. 25 to 27 can be smaller in size than the SBox module of FIGS. 6 to 10, since it is configured to generate four new key values rather than being configured to process an entire state array in parallel (albeit in different stages) and does not implement a separate affine transformation module and does not implement an inverse affine transformation module.

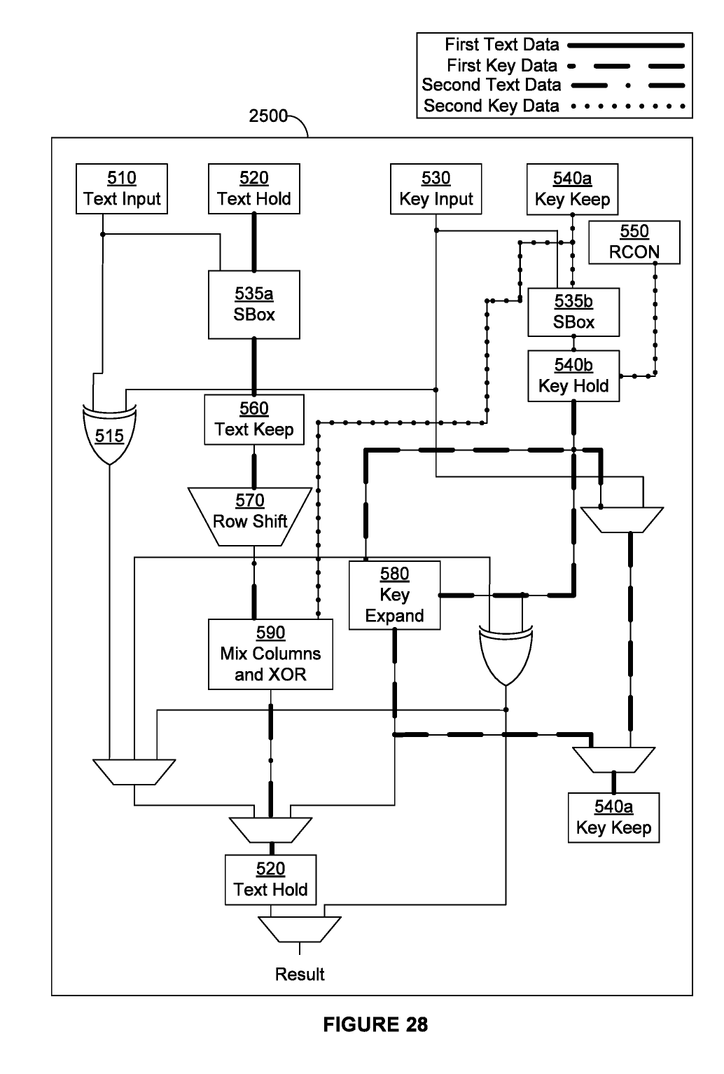

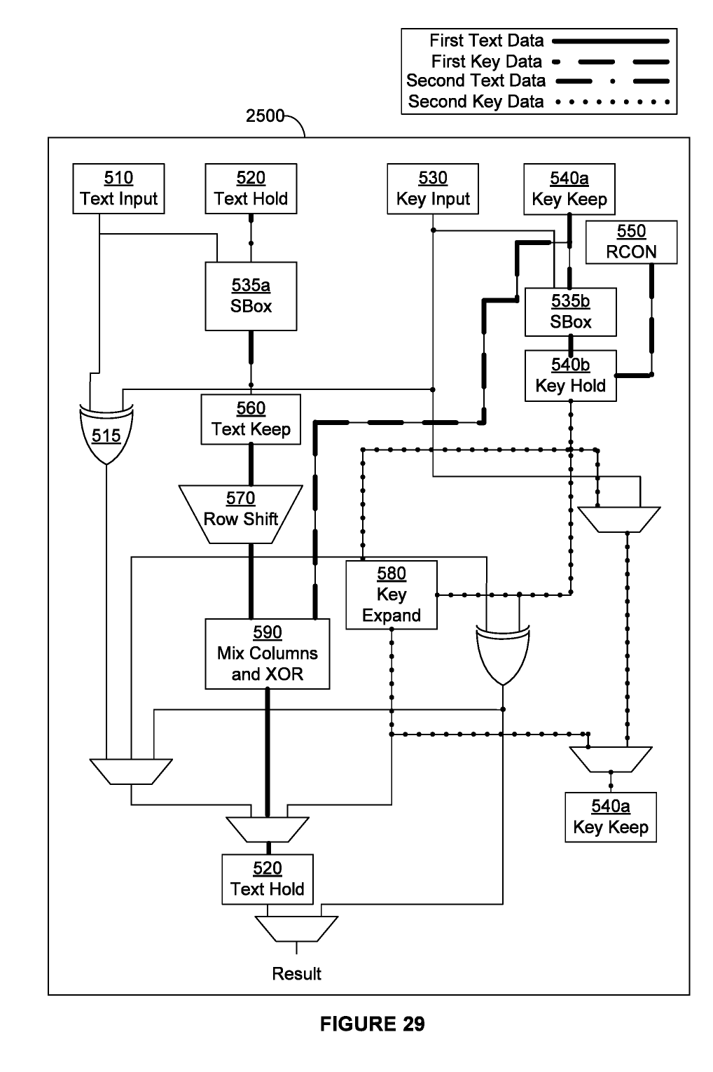

Accordingly, the processing performed by the arrangement of FIGS. 25 to 27 described above is similar to the processing performed in FIGS. 6 to 10 except that an additional SBox module 535b and an additional register (Key Keep register 540a) is used. By providing these additional elements to the hardware arrangement, the hardware arrangement is able to simultaneously process two separate and distinct processes for encryption or decryption (or a combination of encryption and decryption). For example, the hardware implementation is able to simultaneously process a first encryption or decryption method and a second encryption or decryption method, as will be illustrated with reference to FIGS. 28 and 29 below.

FIG. 28 illustrates a round of a first and a different second decryption or encryption method being performed in parallel. As can be seen from FIG. 28, four different types of data is being passed through the hardware implementation simultaneously. Specifically, for a first decryption or encryption method, first key data (illustrated by a dashed line) and first text data (illustrated by a dark solid line) is illustrated. The flow of second key data (illustrated by a dotted line) and second text data (illustrated by a dash-dot line) is also shown for a second decryption or encryption method. As shown in FIG. 28, the first key data and first text data for the first encryption or decryption method is processed as set out above with reference to the first stage processing illustrated in FIG. 26. In parallel with this processing, the second key data and second text data for the second encryption or decryption method is processed as set out above with reference to the second stage illustrated in FIG. 27. In this way, the first key data and the first text data can be considered to be processed by a first portion of the hardware implementation in a first stage. Similarly, the second key data and the second text data can be considered to be processed by a second portion of the hardware implementation in the first stage.

FIG. 29 illustrates the second stage of the processing of the round corresponding to the round being processed in FIG. 28. In the second stage of the processing, first text data and first key data for the first encryption or decryption method is processed in a manner that corresponds with the processing of the second stage as described above with reference to FIG. 27. The second text data and second key data for the second encryption or decryption method is processed in a manner that corresponds with the processing of the first stage as described above with reference to FIG. 26. In the second stage, the first and second portions of the hardware implementation process the other text data and key data to the data processed in the first stage. For example, the first portion processes the second key and text data and the second portion processes the first key and text data.

In this way, the first and second encryption or decryption methods are performed simultaneously, albeit offset by one stage. As mentioned previously, the implementations presented herein may be configured such that a single stage can be performed in a single processor cycle. Accordingly, in the arrangements of FIGS. 26 to 29, the second encryption or decryption method may be performed in parallel with the first encryption or decryption method, albeit offset by one processor cycle. In other arrangements, the second encryption or decryption method may be offset by any other odd number of stages. The throughput of the hardware implementation may be increased at the expense of an increase in hardware logic required to form the hardware implementation.

Reduced Logic

There is also disclosed herein another alternative hardware implementation which may form part of an AES encryption and/or decryption instruction execution module configured to enable end-to-end AES encryption or decryption to be performed. This alternative arrangement requires fewer SBoxes than the implementations described above. Specifically, the arrangement described below utilises only four SBoxes. Put another way, this arrangement is only able to apply an SBox to four bytes in parallel and thus requires less hardware logic to implement that the arrangements set out above. This approach is particularly efficient since hardware logic required to implement an SBox transformation can be costly but the implementation has decreased data throughput and increased latency when compared with the two previous hardware arrangements 500 and 2500, since more stages are required to process a round and thus more processor cycles are required to implement end-to-end AES encryption or decryption with on-the-fly key expansion. However, in some implementations this trade-off in performance for reduced logic may be appropriate.

Generally, for AES encryption and decryption it is possible to apply functions such as SubBytes( ) and ShiftRows( ) to the state array out of order provided that the positions of values in the state array are tracked as they are shifted in position and other functions are applied to the appropriate values. In this way, it is possible to deviate from the specific order specified in the AES standard, provided that the resultant values in the state array at the end of a round conform to the standard. In this reduced logic end-to-end solution, the processing of a round may include performing a portion of key expansion for the subsequent round and processing the data in the state array.

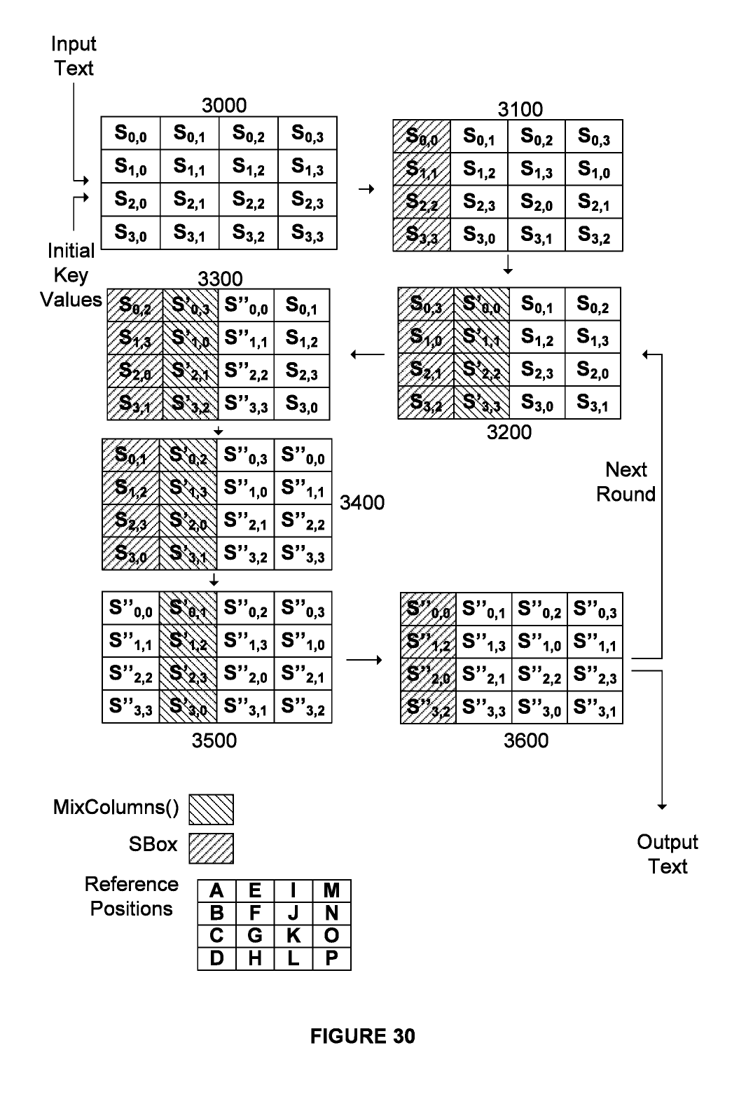

In the previously described implementations, the processing of a round may be separated into two distinct stages (first and second stages), each optionally taking a single processor cycle. In the following arrangement, the processing of a round can be separated into a greater number of different stages as set out in FIG. 30. Specifically, the processing of a round may be illustrated as transitions between a plurality of states. During these transitions, a stage of processing is performed. The processing of an initial round may involve transitioning between six separate states of the state array as illustrated in FIG. 30. Specifically, an initial round may involve transitioning between an initial state 3000, to a first state 3100, a second state 3200, a third state 3300, a fourth state 3400, a fifth state 3500, and to a sixth state 3600. Other rounds may involve transitioning between five states as described below. As shown in FIG. 30, the state array can be considered to comprise sixteen individual values. For the purposes of the following description, the state array will be considered as a 4×4 array with each of the positions A to P being associated with a respective position in the array as shown in FIG. 30. Values may be passed between these reference positions during the processing of the array. In the following implementation, each of the reference positions A to P may have a register associated therewith each configured to hold a value of the state array.

FIG. 30 illustrates an example process for executing rounds for AES encryption. A similar process can also be defined for decryption. In an initial stage for an initial round, input key data is received and retained in a register (not shown) and subsequently expanded (also not shown) similarly to the previous examples. Input text is received and retained in the state array as sixteen values (bytes) denoted S_{0,0} to S_{3,3}. In the initial stage, each of the values S_{0,0} to S_{3,3} are respectively located in specific reference positions A to P in the state array. For example, value S_{0,0} is located at reference position A and S_{3,3} is located at reference position P.

During transitioning from the initial state 3000 to the first state 3100, the values in the state array are processed. In detail, an initial XOR of the values of the state array with the initial key values is performed in accordance with the AddRoundKey( ) function and a ShiftRows( ) function is performed on the state array. Accordingly, in the first state 3100 values in the state array are XOR'd with the corresponding key value and shifted with respect to the initial state. For example, value S_{3,2} is now at reference position P and has been XOR'd with the key value at reference position. In addition, an SBox function is applied for the purposes of generating expanded key values as described previous.

Transitioning from the first state 3100 to the second state 3200 involves the application of an SBox to four of the values of the state array, namely to each of the values S_{0,0}, S_{1,1}, S_{2,2}, and S_{3,3} that are located in reference positions A to D to generate new values S′_{0,0}, S′_{1,1}, S′_{2,2}, and S′_{3,3}. Also in the transition from the first state 3100 to the second state 3200, the processing of the key expansion is completed and a circular shift is applied to all of the values in the state array. The result of the circular shift can be seen in second state 3200 when compared with the corresponding positions in the first state. For example, the value S_{3,2} is now located in the reference position P. Transitioning from the second state 3200 to the third state 3300 involves applying an SBox transformation to the values at reference positions A to D of the state array, namely the values S_{0,3} to S_{3,2}. Furthermore, the values at reference positions E to H are processed according to the MixColumns( ) function and are XOR'ed with appropriate key values. All of the values in the state array again undergo a circular shift to the right (with the right most value becoming the left most value of a row). For the transition from the third state 3300 to the fourth state 3400 and from the fourth state 3400 to the fifth state 3500, an SBox transformation is applied to the values at reference positions A to D and the MixColumns( ) and XOR function is applied to the values at reference positions E to H, followed by a circular shift. Accordingly, all sixteen values in the state array have undergone an SBox transformation. From the fifth state 3500 to the sixth state 3600, the fourth and final MixColumns( ) and XOR function is applied. During this transition, the SBox module is configured to be used for key expansion and the ShiftRows( ) function is performed for a subsequent round.

For a subsequent round, the transition from sixth state 3600 to second state 3200 involves the same processing as the transition from first state 3100 to second state 3200, namely SBox transformations for the values at reference positions A to D, the completion of the key expansion, and the application of a circular shift to the values of the state array. For intermediate rounds, the looping of transitions from the second state to the sixth state are repeated with each intermediate loop including a second state, a third state, a fourth state, a fifth state, and a sixth state. For the final round, the second to sixth states are transitioned as with the intermediate rounds except that the MixColumns( ) function is not performed. After the sixth state has been transitioned to when processing in the final round, the values generated in the sixth state form the output result. The values in the state array should be selected in a manner that effectively “un-does” the final ShiftRows( ) function.

Accordingly, it will be appreciated in the arrangement of FIG. 30, the values in reference positions A to D of the state array may undergo an SBox transformation and the values in reference positions E to H of the state array may be processed according to the MixColumns( ) and XOR functions. In this way, the reference positions that are processed according to the different functions are fixed and the circular shifts are used to move or shift different values of the state array into the reference positions for processing. In this way, it is only necessary to include in the implementation hardware logic that is capable of processing four values of the state array in each transition between states, i.e. in separate stages that may each take a processor cycle. Also, the MixColumns( ) function is applied to only one column of the state array at a time instead of all four columns of the state array. In this way, the silicon area of three MixColumns( ) modules is saved.

This arrangement comprises four SBoxes each configured to process one of the values in the state array. Accordingly, in the transitions between states the SBoxes process four values. In some states, the SBox processes values in the state array. For the other states, the SBoxes are not needed to process the state array. The SBoxes may therefore be used as part of the key generation process to perform a portion of the key expansion required to generate a round key for use in the subsequent round.

As with the two hardware implementations 500 and 2500 described above, the generation of a round key requires two steps. In these arrangements, 16 and 20 SBoxes are respectively implemented so that the two steps of key generation are performed over two stages. In a first step, key values are passed through an SBox module to partially generate key values for use in the subsequent round. In a second step, as described previously, the partially generated key values are passed through a Key Expand module to generate the round key for the subsequent round.

In the four SBox arrangement of FIG. 30, for a current round the partially generated key values are calculated in a first transition between states by passing key values through the SBoxes. Then, during the next transition between states, the partially generated key values are passed to the Key Expand module to complete the generation of the round key for use in that round at the same time that the MixColumns( ) function is applied to just one of the four columns.

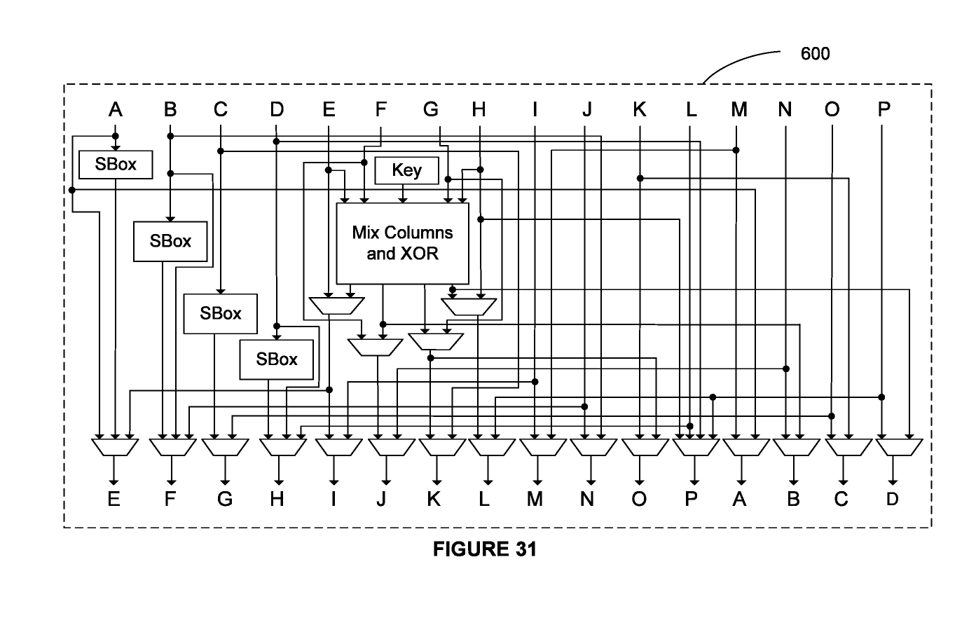

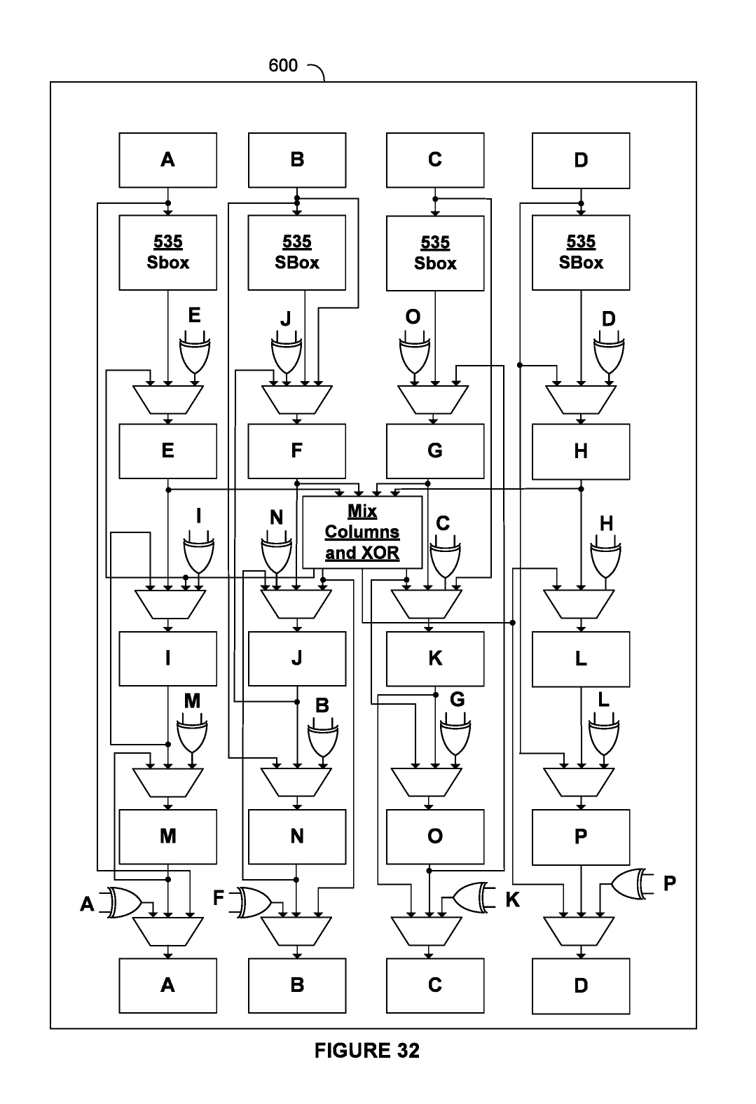

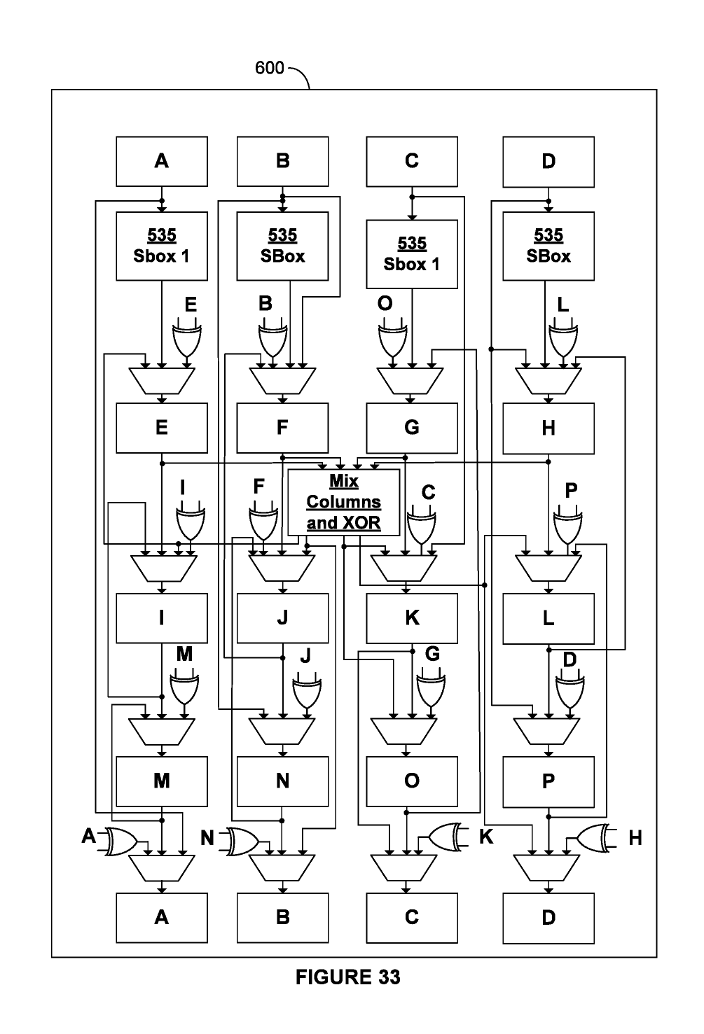

FIG. 31 illustrates an example overview of a hardware implementation 600 configured to implement each of the transitions between the states defined above for encryption (and corresponding state transitions for decryption). The XOR gates used to perform the XOR calculation of the initial key data and the values of the state array in the transition from state 3000 to state 3100 are not illustrated in this figure for the purposes of clarity. Specifically, the hardware implementation 600 comprises four SBoxes, each configured to operate on one of the values of the state array in a particular stage. The hardware implementation further comprises hardware logic for implementing a MixColumns( ) function on four values that together define a column of the state array. The hardware implementation 600 further comprises a plurality of registers referenced in FIG. 31 as registers A to P. Registers A to P are configured to store intermediate values during the processing of the state array and each correspond with a reference position of the state array as illustrated above with reference to FIG. 30. The hardware can be considered static in that the hardware comprises a subset of the registers that are configured to provide inputs to the SBoxes and MixColumns( ) hardware. In contrast, the values in the state array pass dynamically through the hardware such that different values are passed through the SBoxes and MixColumns( ) hardware during each stage of the processing of a round and then are passed to different registers for storage. The arrangement of FIG. 31 is illustrated again with reference to FIG. 32 in which signal flow through the digital circuitry is illustrated in more detail, and the digital circuitry includes a plurality of XOR gates. FIG. 33 illustrates corresponding signal flow through the digital circuitry for decryption.

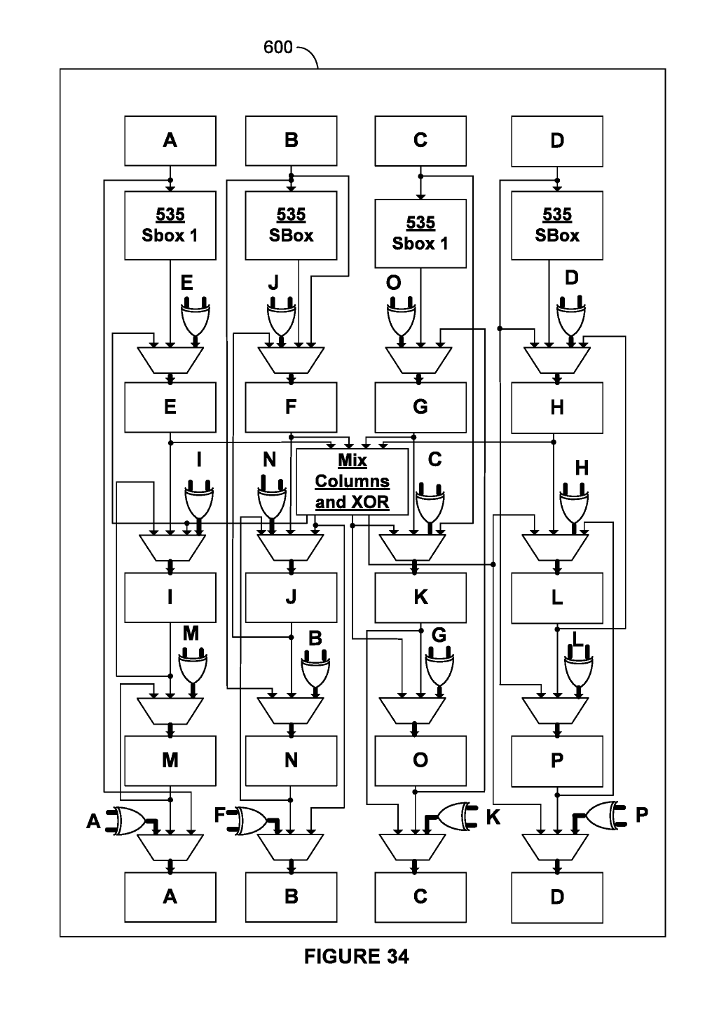

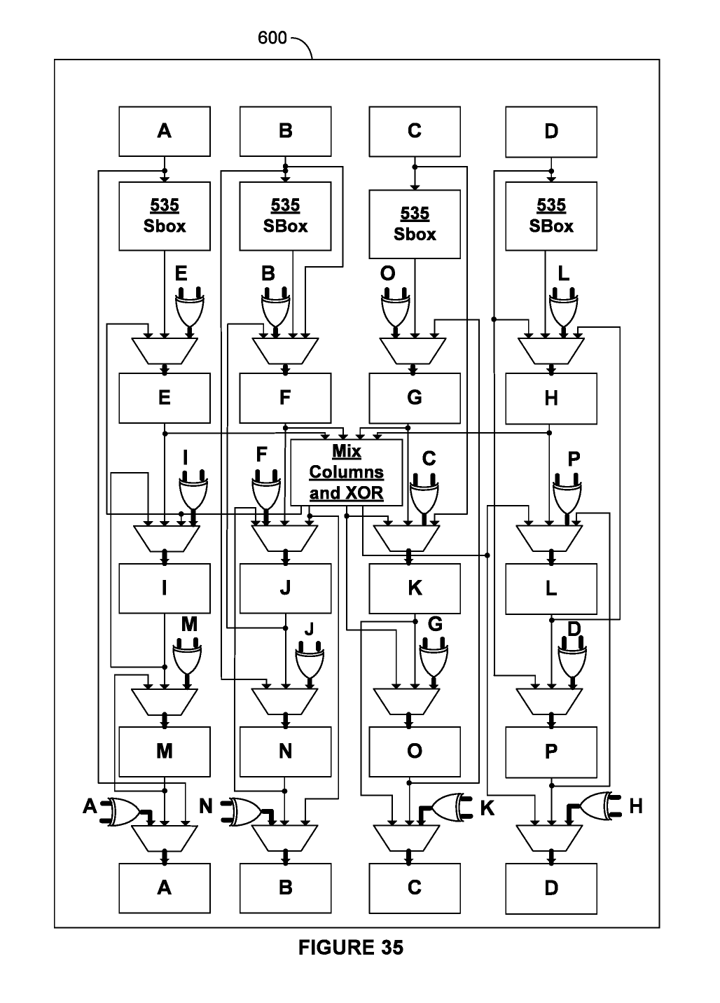

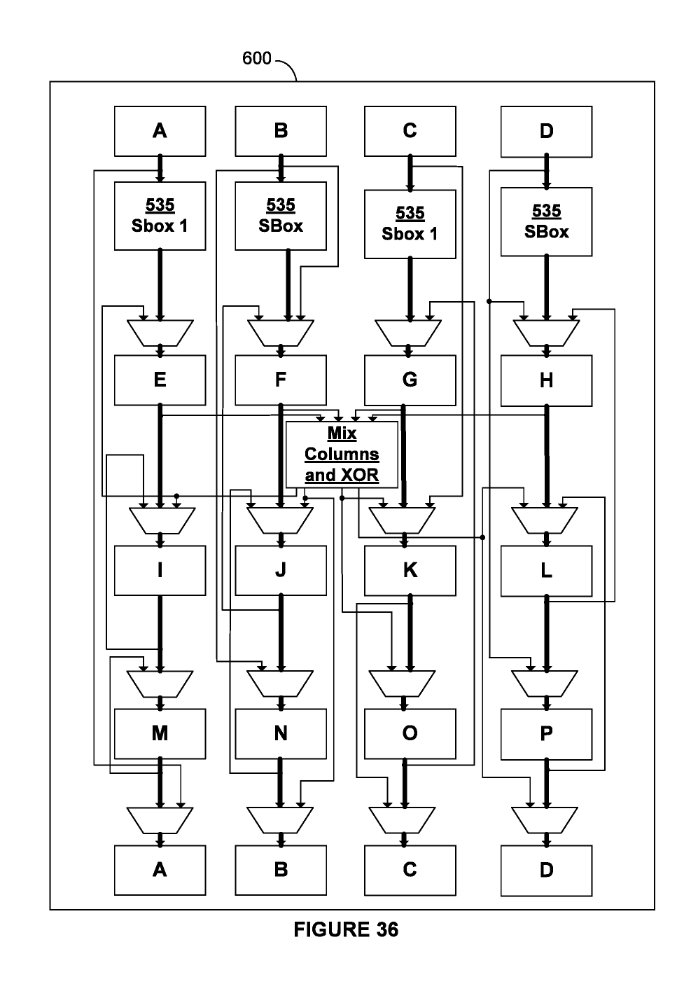

In the four SBox arrangement set out herein, the processing of a transition from an initial state 3000 to a first state 3100 of an initial round is illustrated in FIG. 34 for encryption. In the arrangement of FIG. 34, the ShiftRows( ) function and the AddRoundKey( ) function are performed based upon the initial key values provided to the hardware logic 600. The ShiftRows( ) function is advantageously performed without the use of an instantiated shifter module by instead appropriately connecting registers. The AddRoundKey( ) function is performed by connecting an appropriate register to an input of an XOR gate and connecting as another input to the XOR gate a round key value that corresponds with that position in the state array. The XOR gates illustrating this XOR calculation to perform the initial AddRoundKey( ) function and the shifting of values between reference positions of the state array is illustrated by the passage of data along the dark lines in FIG. 34 (for encryption) and FIG. 35 (for decryption). For example, in the ShiftRows( ) function, the positions of values that were originally located at reference positions A, E, I, and M remain unchanged and the inputs to these registers are the result of XOR'ing the respective register values with initial key values at corresponding positions of a 4×4 array of key values. For example, the key value at a reference position A of a 4×4 array of key values is XOR'd with a corresponding text value at position A of the state array. For other registers, the inputs to the corresponding XOR gates are from other registers in accordance with the ShiftRows( ) function. In addition, the SBox is used for key expansion during this transition.

FIG. 35 illustrates a transition from an initial state 3000 to a first state 3100 for an initial round for decryption and differs in that different key values are input to the XOR gates and that the InvShiftRows( ) function is used instead of the ShiftRows( ) function. The InvShiftRows( ) function is similarly implemented without the need for a shifter through appropriate connection of registers. As can be seen in both FIGS. 34 and 35, the registers are each accessed via a multiplexer that is configured to select an input from a plurality of different inputs based upon which stage of the processing of a round the hardware is implementing. The selected inputs in the initial stage are illustrated in FIGS. 34 and 35 as appropriate. As will be appreciated, the registers S_{0,0} to S_{3,0} are illustrated twice for the purposes of clarity but are only instantiated once in practice.

FIG. 36 illustrates the transition from a first state 3100 to a second state 3200 of the initial round. In FIG. 36, the dark lines indicate the transfer of data through the hardware logic 600. In this arrangement, the SBox function is applied to the values stored in registers A to D, which are the values S_{0,0}, S_{1,1}, S_{2,2}, and S_{3,3} that were originally stored in registers A, F, K, and P. These processed values are then stored in registers E, F, G, and H. The hardware arrangement of the transition from the first state 3100 to the second state 3200 illustrated in FIG. 36 is common to both encryption and decryption but differs in that the SBox modules through which data is passed will each be configured for encryption or decryption, depending on which of encryption or decryption is to be performed.

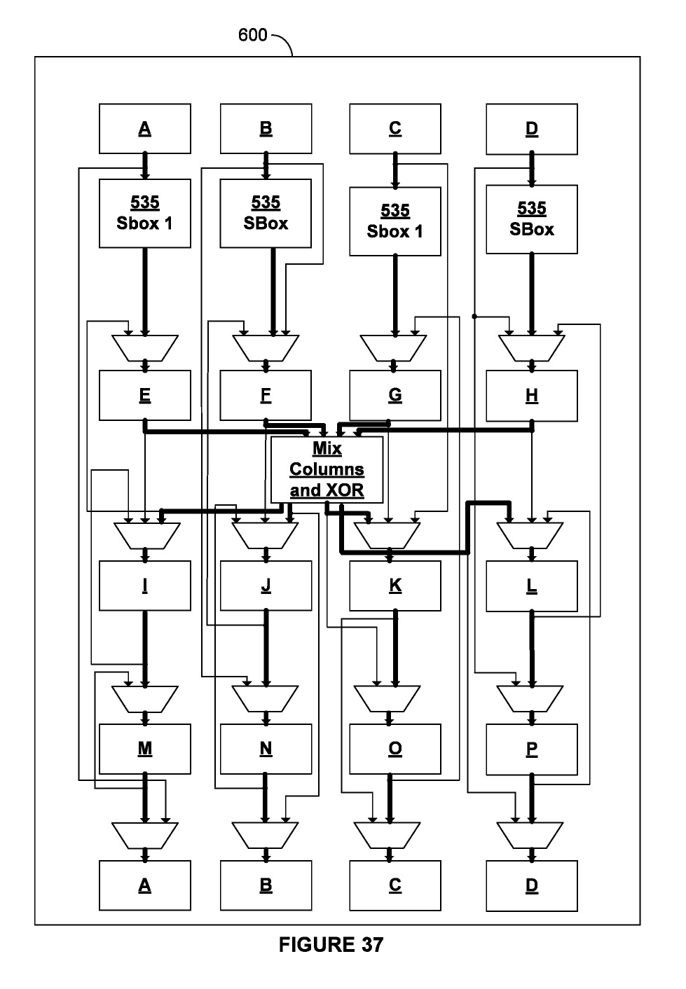

FIG. 37 illustrates the operation of the hardware implementation 600 for performing any of the transitions from the states from the second state 3200 to fifth state 3500 for an initial round. In the arrangement of FIG. 37, values in positions A to D from the state array are passed through the SBoxes and values in positions E to H from the state array to the Mix Columns and XOR module and are then passed to other registers, where the dark lines indicate the passing of data through the hardware implementation.

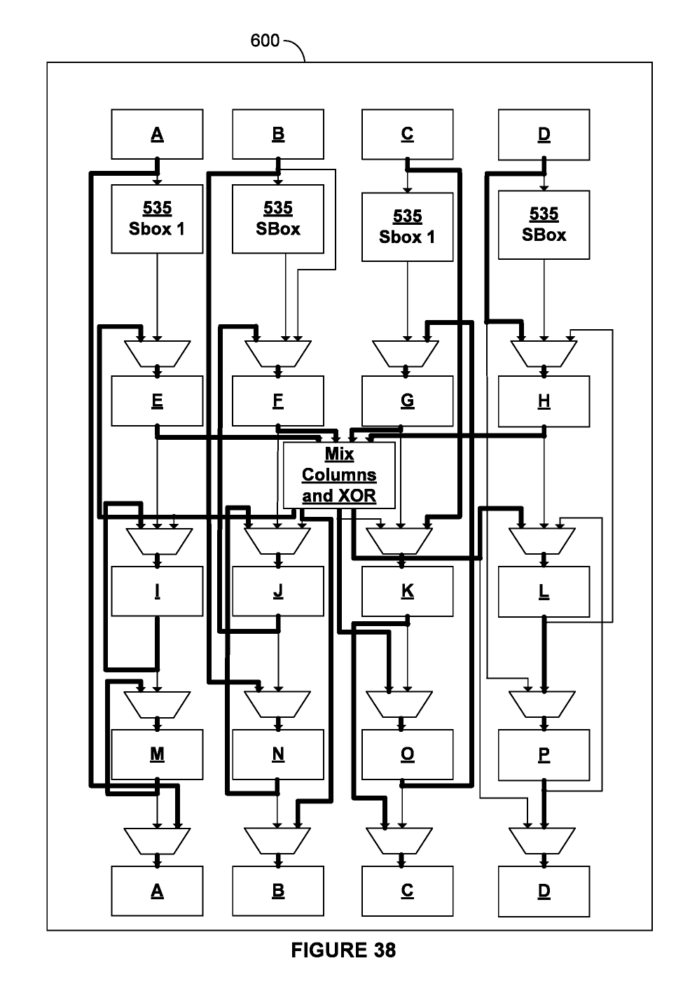

FIG. 38 illustrates the operation of the hardware implementation 600 for performing the transition from the fifth state 3500 for an initial round of encryption.

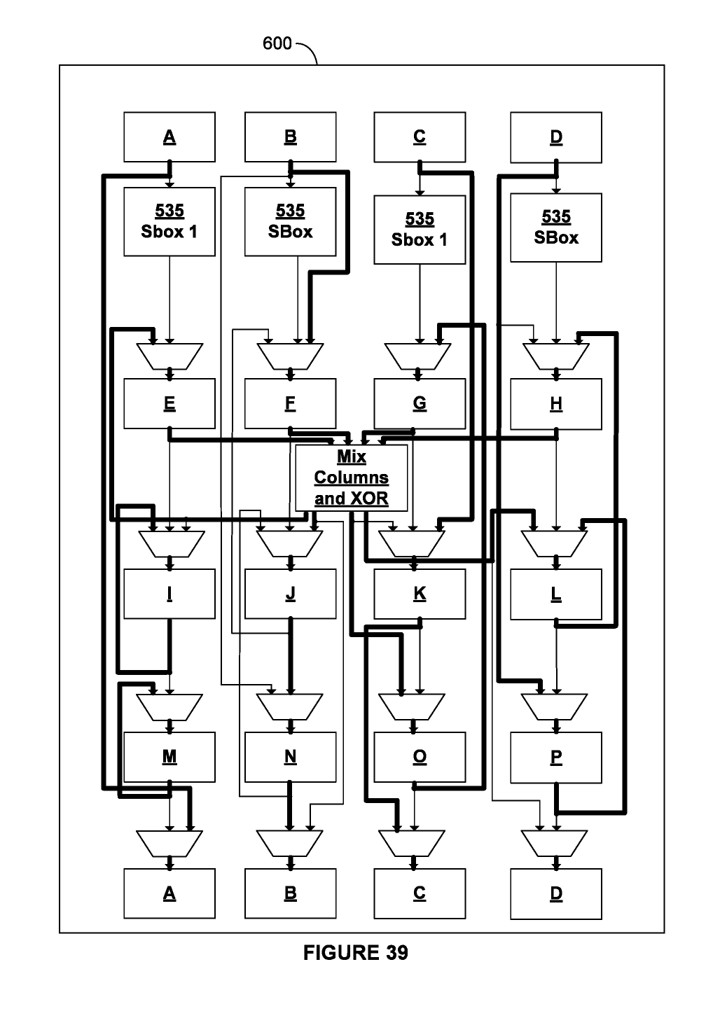

In the arrangement of FIG. 38, it will be appreciated that the SBox modules are not required for use in processing the state array since all sixteen values of the state array have already been processed. Accordingly, the values of the state array are not passed to the SBox modules, which are instead configured to perform a portion of the key expansion as described above. Instead, the hardware arrangement 600 is configured to pass values through the Mix Columns and XOR module in order to apply the key values. Similarly, the hardware arrangement illustrated in FIG. 39 is configured to perform the transition to the sixth state 3600 for decryption.

For subsequent rounds of AES encryption or AES decryption, it is not necessary to implement the transition to the first state 3100 since in subsequent rounds, the processing that is performed in the transition to the first stage 3100 for a particular round can be integrated into the transition to the sixth state for the previous round, as will be illustrated in the table set out below. In the following example, each stage takes a single processor cycle to execute. However, in other arrangements it will be appreciated that stages may take more than one processor cycle to execute.

| | Cycle and | | |
|---|---|---|---|
| Encryption | Transition | Rnd | Decryption |
| Row Shift, SBox for | 1 | 1 | Inv Row Shift, SBox |
| Key Expand, XOR | 3000−>3100 | | for Key Expand, XOR |
| SBox, XOR and finish | 2 | 1 | Inv SBox, XOR and |
| key expansion | 3100−>3200 | | finish key expansion |
| SBox, Mix Columns, | 3 | 1 | Inv SBox, Inv Mix |
| XOR | 3200−>3300 | | Columns, XOR |
| SBox, Mix Columns, | 4 | 1 | Inv SBox, Inv Mix |
| XOR | 3300−>3400 | | Columns, XOR |
| SBox, Mix Columns, | 5 | 1 | Inv SBox, Inv Mix |
| XOR | 3400−>3500 | | Columns, XOR |
| SBox for Key Expand, | 6 | 1 | SBox for Key Expand, |
| Mix Columns, Row | 3500−>3600 | | Inv Mix Inverse |
| Shift, XOR | | | Columns, Inv Row |
| | | | Shift, XOR |
| SBox, XOR and finish | 7 | 2 | Inv SBox, XOR and |
| key expansion | 3600−>3200 | | finish key expansion |
| SBox, Mix Columns, | 8 | 2 | Inv SBox, Inv Mix |
| XOR | 3200−>3300 | | Columns, XOR |
| SBox, Mix Columns, | 9 | 2 | Inv SBox, Inv Mix |
| XOR | 3300−>3400 | | Columns, XOR |
| SBox, Mix Columns, | 10 | 2 | Inv SBox, Inv Mix |
| XOR | 3400−>3500 | | Columns, XOR |
| SBox for Key Expand, | 11 | 2 | SBox for Key Expand, |
| Mix Columns, XOR, | 3500−>3600 | | Inv Mix Columns, XOR, |
| Row Shift | | | Inv Row Shift |
| . . . | . . . | . . . | . . . |
| Sbox for Key Expand, | 5(N_{R} − 1) + 6 | N_{R} − | SBox for Key Expand, |
| Mix Columns, XOR, | 3500−>3600 | 1 | Inv Mix Columns, XOR, |
| Row Shift | | | Inv Row Shift |
| SBox and finish | 5(N_{R} − 1) + 2 | N_{R} | Inv SBox and finish |
| key expansion | 3600−>3200 | | key expansion |
| SBox, XOR | 5(N_{R} − 1) + 3 | N_{R} | Inv SBox, XOR |
| | 3200−>3300 | | |
| SBox, XOR | 5(N_{R} − 1) + 4 | N_{R} | Inv SBox, XOR |
| | 3300−>3400 | | |
| SBox, XOR | 5(N_{R} − 1) + 5 | N_{R} | Inv SBox, XOR |
| | 3400−>3500 | | |
| XOR | 5(N_{R} − 1) + 6 | N_{R} | XOR |
| | 3500−>3600 | | |

The above table illustrates the operation of hardware implementation 600 for each of a plurality of rounds, N_{R}. As illustrated in the above table, the initial round (Rnd=1) takes six processor cycles, where each processing cycle a transition between states occurs. Specifically, for the initial round, each transition from first to sixth states is performed as described above. For intermediate rounds (Rnd=2 to Rnd=N_{R}−1), five processor cycles are required since the transition from the initial state to the first state is not performed in subsequent rounds. Instead, the functions performed for the transition from the initial state 3000 to the first state 3100 of the initial round are performed in the transition from the fifth state 3500 of the previous round to the sixth state 3600 of the previous round. In addition, the transition from the first state 3100 to the second state 3200 in the subsequent round is performed on the transition from the sixth state 3600 to the second state 3200 of the subsequent round. Specifically, the ShiftRows( ) and SBox processing for key expansion is performed between fifth 3500 and sixth 3600 states and the application of the SBox to the state array, completion of key expansion, and the circular shift are performed between states 3600 for the previous round and 3200 for the subsequent round. In the final round, N_{R}, five transitions between states are performed. In the first four transitions of the final round only the XOR for the AddRoundKey( ) is performed in the Mix Columns and XOR module and the MixColumns( ) function (or InvMixColumns( ) function, as appropriate) is not performed. The final (fifth) transition of the final round involves an XOR of the final round key with four values from the state array.

It will be appreciated that the arrangements of FIGS. 32 to 39 illustrate the various data flow paths through the hardware logic to implement encryption and decryption. The connections shown in these Figures are for the purposes of illustration only. The connections illustrated in these Figures can be combined or modified as will be appreciated by the skilled person to provide a single piece of circuitry operable to implement encryption and decryption, when operating in different modes. Furthermore, the circuitry may be implemented separately so that the circuitry is configured to perform only one of encryption and decryption.

Implementation within a Processor

As mentioned previously, the approaches described herein are particularly applicable within a processor having an instruction set, such as a general-purpose processor or general purpose CPU. The instruction set may include a plurality of opcodes which are operations for performing end-to-end AES encryption or decryption. One option is to define in the instruction set six separate instructions, namely a separate instruction for each of AES128 encryption, AES128 decryption, AES192 encryption, AES192 decryption, AES256 encryption, and AES256 decryption.

Each of these opcodes may be configured to have associated therewith a number of operands. For example, opcodes for AES128 may use two operands of a predetermined width, such as 16 bytes. The first operand may therefore be configured to include the initial text (either message text or cipher text) that forms the 4×4 byte state array to be processed by the end-to-end algorithm. A second operand may be configured to include a portion (e.g. 16 bytes) of the initial key values, i.e. the key values that form the round key for the initial round. For AES192 and AES256, a third operand may also be configured to store the remaining number of bytes of the initial key values. In the example of AES192, 8 bytes of key data are placed in the third operand. In the example of AES256, 16 bytes are placed in the third operand. It will be appreciated that, in other arrangements, different combinations of operands and operand sizes may be used.

A processor having instructions in the instruction set for performing end-to-end AES encryption and/or AES decryption is therefore configured to execute the instruction in the usual manner and to retrieve from memory the key data and the text data. These values are then passed to the hardware implementation along with some control signals that initiate the processing of end-to-end AES encryption or decryption. Specifically, control signals may be sent to the hardware implementation to initiate the processing of the key and text data. The control signals may also signal to the hardware implementation which key length (128, 192, or 256) is to be used as well as which of encryption or decryption is to be used.

The hardware logic may include control logic that is configured to receive the control signals and to configure the modules within the hardware implementation to perform one of the six possible implementations (AES 192, 256, and 128 for encryption and decryption). For example, the SBox and Key Expand modules and the various multiplexers may be configured for each of the number of rounds to be performed

In the implementations described herein, the hardware logic is configured to perform either AES encryption or AES decryption without any further data being passed to the hardware implementation. Since the key information is generated on-the-fly, no further instructions need to be issued or executed in order for the resultant state array to be generated and passed back to the processor.

The above description refers to registers (including a Text Hold register, a Text Input register, a Text Keep register, a Key Input register, a Key Hold register, and a Key Keep register) as modules or elements in which key data or text data is stored between stages of processing rounds. The term is not intended to refer to the storage of data into a memory having a series of addresses, such as Main Memory. Instead, the registers are typically implemented as flip-flops or latches in which data is held or retained in the register, typically only for a processor cycle, and the released. The registers typically do not have persistent storage that lasts beyond a processor. Accordingly, reference herein to the storage of data in a register is reference to the temporary holding or retaining of data in the register persisting typically for a single processor cycle, until the data is clocked out of the register by a rising or falling edge of a clock signal.

In the present implementation, at least six registers are defined and the values to be stored in those registers during each processor cycle are also defined. Accordingly, unlike storing values to main memory, it is not necessary to utilise addressing to store the values. Similarly, it is also not necessary to use the processor pipeline to hold values. Put another way, the operation of the hardware logic may be performed within the processor but without requiring memory transactions in the processor pipeline by holding the relevant values in registers within the hardware logic and thus without having to pass values to and from memory using the processor.

In some arrangements, the hardware logic described herein may be configured to implement only one of AES encryption and decryption. In this way, the instruction opcode does not need to define which of AES encryption and decryption is to be performed.

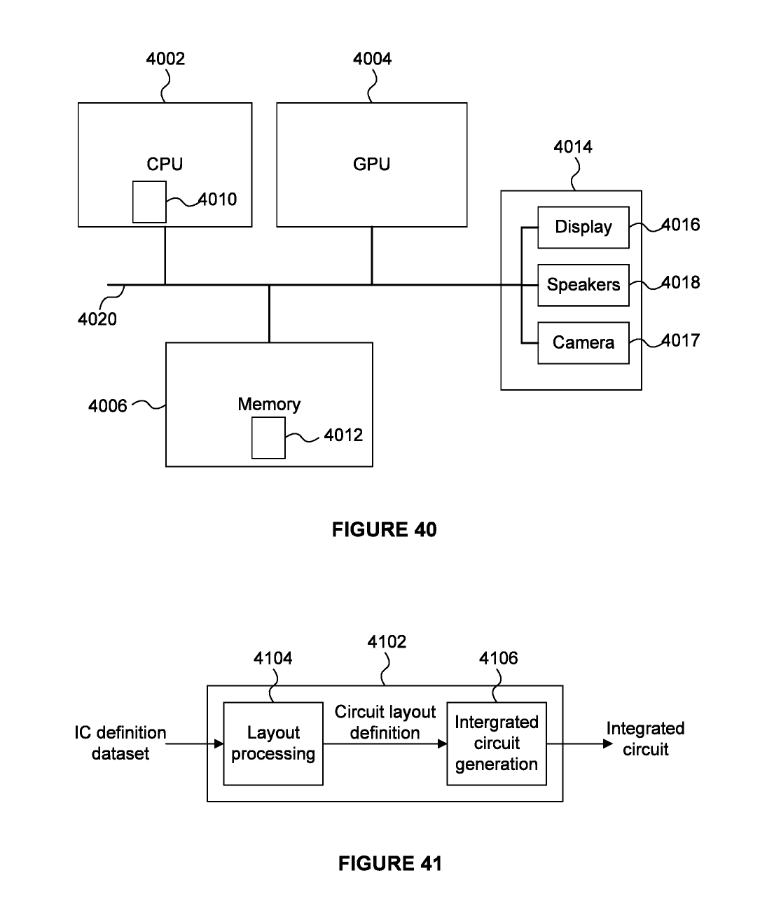

FIG. 40 shows a computer system in which the hardware logic configured to perform at least one of end-to-end AES encryption and decryption described herein may be implemented. The computer system comprises a CPU 4002, a GPU 4004, a memory 4006 and other devices 4014, such as a display 4016, speakers 4018 and a camera 4017. The hardware logic described herein may be implemented in a processing block 4010 on the CPU 4002. In other examples, the processing block 4010 may be implemented on the CPU 4004. The components of the computer system can communicate with each other via a communications bus 4020. A store 4012 is implemented as part of the memory 4006.

The hardware logic illustrated in FIGS. 6 to 39 is shown as comprising a number of functional blocks. This is schematic only and is not intended to define a strict division between different logic elements of such entities. Each functional block may be provided in any suitable manner. It is to be understood that intermediate values described herein as being formed by hardware logic need not be physically generated by the hardware logic at any point and may merely represent logical values which conveniently describe the processing performed by the hardware logic between its input and output.

The hardware logic described herein may be embodied in hardware on an integrated circuit. The hardware logic described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be any kind of general purpose or dedicated processor, such as a CPU, GPU, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed in an integrated circuit manufacturing system configures the system to manufacture hardware logic configured to perform any of the methods described herein, or to manufacture hardware logic comprising any apparatus described herein. An integrated circuit definition dataset may be, for example, an integrated circuit description.

An integrated circuit definition dataset may be in the form of computer code, for example as a netlist, code for configuring a programmable chip, as a hardware description language defining an integrated circuit at any level, including as register transfer level (RTL) code, as high-level circuit representations such as Verilog or VHDL, and as low-level circuit representations such as OASIS (RTM) and GDSII. Higher level representations which logically define an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

An example of processing an integrated circuit definition dataset at an integrated circuit manufacturing system so as to configure the system to manufacture hardware logic will now be described with respect to FIG. 41.

FIG. 41 shows an example of an integrated circuit (IC) manufacturing system 4102 which comprises a layout processing system 4104 and an integrated circuit generation system 4106. The IC manufacturing system 4102 is configured to receive an IC definition dataset (e.g. defining hardware logic as described in any of the examples herein or defining a processor including such hardware logic), process the IC definition dataset, and generate an IC according to the IC definition dataset (e.g. which embodies hardware logic as described in any of the examples herein or embodies a processor including such hardware logic). The processing of the IC definition dataset configures the IC manufacturing system 4102 to manufacture an integrated circuit embodying hardware logic as described in any of the examples herein.

The layout processing system 4104 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 4104 has determined the circuit layout it may output a circuit layout definition to the IC generation system 4106. A circuit layout definition may be, for example, a circuit layout description.

The IC generation system 4106 generates an IC according to the circuit layout definition, as is known in the art. For example, the IC generation system 4106 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 4106 may be in the form of computer-readable code which the IC generation system 4106 can use to form a suitable mask for use in generating an IC.

The different processes performed by the IC manufacturing system 4102 may be implemented all in one location, e.g. by one party. Alternatively, the IC manufacturing system 4102 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture hardware logic without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 41 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 41, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

1. A method of performing at least one of end-to-end AES (Advanced Encryption Standard) encryption and end-to-end AES decryption in an instruction execution module comprising hardware logic in a processor having an instruction set, the method comprising:
receiving in response to a particular instruction from the instruction set being executed, key values and text data identified by operands in the executed instruction, the received key values defining an initial round key and forming current key values and the received text data defining an initial state array to be processed in an initial round and forming a current state array;
for each round of a plurality of rounds of AES encryption or decryption, modifying the current key values and modifying the current state array by:
processing the current state array using at least a portion of the current key values;
generating key values based upon the current key values for use in a subsequent round; and
updating the current key values to replace at least a portion of the current key values with the generated key values to form a round key for use in a subsequent round.

2. The method of claim 1, wherein the steps of processing the current state array and generating key values for a particular round comprise a first stage and a second stage, and
wherein, for a particular round, the first stage comprises:
completing generation of key values by processing partially generated key values that had been initiated in a previous round and holding the generated key values; and
initiating the processing of the current state array to generate partially processed text values; and
wherein, for a particular round, the second stage comprises:
initiating generation of key values for the next round to generate partially generated key values; and
completing the processing of the current state array for the round based upon the partially processed text values.

3. The method of claim 2, further comprising, in the first stage of processing a particular round, holding in a Text Keep register partially processed text values and, in the second stage of processing a particular round, holding in a Text Keep register partially processed key values.

4. The method of claim 1, further comprising a Key Expand module configured to perform at least a portion of the generation of key values, wherein the Key Expand module is configured to generate key values based upon which of AES encryption or decryption is to be performed and the AES key length to be used.

5. The method of claim 4, wherein the Key Expand module is configured, in the first stage, to complete the generation of key values based upon partially generated key values.

6. The method of claim 1, further comprising an SBox module configured to perform at least one SBox transformation, wherein the SBox module is configured to operate in a first mode and at least one of a second mode and a third mode, wherein the first mode is a key expansion mode, a second mode is an encryption mode, and a third mode is a decryption mode.

7. The method of claim 6, wherein the received text data forms a first current state array and the method further comprises receiving second received key values, the second received key values defining a second initial round key for processing second end-to-end AES encryption or decryption and receiving second text data forming a second current state array to be processed in parallel with the first current state array; and
wherein the SBox module is a first SBox module and the method further comprises processing key data using a second SBox module and processing text data using the first SBox module.

8. The method of claim 7, wherein the method comprises, in a first stage of processing a particular round:
completing generation of first key values by processing partially generated first key values that had been initiated in a previous round and holding the first generated key values; and
initiating the processing of the first current state array to generate partially processed first text values;
completing the processing of the second current state array using current second key values; and
initiating generation of second key values for the next round to generate partially generated second key values; and
in a second stage of processing a particular round:
completing generation of second key values by processing partially generated second key values;
initiating the processing of the second current state array to generate partially processed second text values;
completing the processing of the first current state array using first key values; and
initiating generation of first key values for the next round to generate partially generated first key values.

9. The method of claim 6, wherein the SBox module is configured to perform an SBox transformation on four bytes in parallel and, wherein processing a current state array using at least a portion of the current key values comprises a plurality of stages in which a portion of the current state array undergoes an SBox transformation in a respective stage of a plurality of stages and a further stage in which key values are generated.

10. The method of claim 1, wherein the instruction set comprises a plurality of instructions each respectively defining which of encryption or decryption to perform and the AES key length to use.

11. The method of claim 1, further comprising performing a configuration of the hardware logic to operate in one of a number of different modes of operation based upon the opcode of a received instruction from the instruction set.

12. A processor having an instruction set, the processor comprising an instruction execution module comprising hardware logic configured to perform at least one of end-to-end AES (Advanced Encryption Standard) encryption and end-to-end AES decryption, the instruction execution module configured to:
receive in response to a particular instruction from the instruction set being executed, key values and text data identified by operands in the executed instruction, the received key values defining an initial round key and forming current key values and the received text data defining an initial state array to be processed in an initial round and forming a current state array; and
for each round of a plurality of rounds of AES encryption or decryption:
processing the current state array using at least a portion of the current key values;
generating key values based upon the current key values for use in a subsequent round; and
updating the current key values to replace at least a portion of the current key values with the generated key values to form a round key for use in a subsequent round.

13. The processor of claim 12, wherein processing the current state array and generating key values for a particular round comprise a first stage and a second stage; and
wherein, for a particular round, the first stage comprises:
completing generation of key values by processing partially generated key values that had been initiated in a previous round and holding the generated key values; and
initiating the processing of the current state array to generate partially processed text values; and
wherein, for a particular round, the second stage comprises:
initiating generation of key values for the next round to generate partially generated key values; and
completing the processing of the current state array for the round based upon the partially processed text values.

14. The processor of claim 12, further comprising an SBox module configured to perform at least one SBox transformation, wherein the SBox module is configured to operate in a first mode and at least one of a second mode and a third mode, wherein the first mode is a key expansion mode, a second mode is an encryption mode, and a third mode is a decryption mode.

15. The processor of claim 14, wherein the SBox module is configured to operate in the first mode during a second stage and is configured to operate in either the second mode or the third mode during a first stage.

16. The processor of claim 15, wherein the SBox module is configured, in the first stage, to generate partially processed text values and to hold the partially processed text values in a Text Keep register and is configured, in the second stage, to generate partially processed key values and to hold the partially processed key values in the Text Keep register.

17. The processor of claim 14, wherein the received text data forms a first current state array and the hardware implementation is configured to receive second received key values, the second received key values defining a second initial round key for processing second end-to-end AES encryption or decryption and receive second text data forming a second current state array to be processed in parallel with the first current state array; and
wherein the SBox module is a first SBox module and the hardware implementation is configured to process key data using a second SBox module and process text data using the first SBox module.

18. The processor of claim 12, wherein the instruction set comprises a plurality of instructions each respectively defining which of encryption or decryption to perform and the AES key length to use.

19. The processor of claim 12 wherein the hardware logic is configurable to operation in one of a number of different modes of operation based upon the opcode of a received instruction from the instruction set.

20. A non-transitory computer readable storage medium having stored thereon a computer readable description of an integrated circuit that, when processed in an integrated circuit manufacturing system, causes the integrated circuit manufacturing system to manufacture a processor, wherein the processor has as instruction set and comprises an instruction execution module comprising hardware logic configured to perform at least one of end-to-end AES (Advanced Encryption Standard) encryption and end-to-end decryption, the instruction execution module configured to:
receive, in response to a particular instruction from the instruction set being executed, key values defining an initial round key and forming current key values and the received text data defining an initial state array to be processed in an initial round and forming a current state array;
for each round of a plurality of rounds of AES encryption or decryption, modify the current key values and modify the current state array by:
processing the current state array using at least a portion of the current key values; and
generating key values based upon the current key values for use in a subsequent round; and
updating the current key values to replace at least a portion of the current key values with the generated key values to form a round key for use in a subsequent round.
